(19) United States
(12) Patent Application Publication
(10) Pub. No.: US 2012/0109399 A1
(43) Pub. Date: May 3, 2012

(54) ENERGY RESOURCE CONSERVATION SYSTEMS AND METHODS

(76) Inventor: Bao Tran, (US)

(21) Appl. No.: 13/342,032

(22) Filed: Jan. 1, 2012

(51) Int. Cl. G06F 1/32

(52) U.S. Cl. 700/296

(57) ABSTRACT

An energy saving system includes a utility controller to transmit a signal for a demand response period or a peak energy price for a peak pricing period from a utility facility; and a display receiving the signal from the utility controller, the display having a first brightness mode operative during the demand response period or the peak pricing period, and a second brightness mode for other period.

### BACKGROUND

This invention relates generally to systems and methods to conserve energy.

The ever increasing need for electricity has historically been satisfied by building more power plants. However, the projected load growth and other external forces are pointing to projected peak capacity shortage in the near future. One option to meet peak demand is called demand-response (DR). DR uses technology and incentives to change electricity consumption by end-use customers. It can result in a reduction in energy consumption at times of peak use and at times of high wholesale market prices. DR offers benefits to both utilities and consumers in the form of increased electric system reliability and reduced price volatility. It uses a wide range of technologies offering a variety of options for both peaking and energy capacities across the electrical system.

Energy demand at a premise varies over the time of day. In a typical home there is a peak in the morning when the family gets up, turns on lights, radios and televisions, cooks breakfast, and heats hot water to make up for the amount used in showers. When the family leaves for work and school it may leave the clothes washer and dishwasher running, but when these are done, demand drops to a lower level but not to zero as the air conditioners, refrigerators, hot waters and the like continue to operate. Usage goes up as the family returns, peaking around dinner when the entire family is home. This creates the typical “double hump” demand curve. Businesses tend to follow different patterns depending on the nature of the business. Usage is low when the office is closed and relatively constant when the office is open. In extreme climates where air conditioning cannot be cut back overnight, energy use over the course of the day is more constant. Businesses such as restaurants may start later in morning and their peaks extend farther into the evening. A factory with an energy intensive process operating three shifts may show little or variation over the course of the day.

It is known that air conditioning/heating costs account for about half of the energy costs and thus dominate the electrical consumption in buildings. Lighting accounts for another significant portion of energy consumption. While smaller, TVs and displays are fast becoming the bane of power bills across millions of households. Flat panel TVs consume about 4 percent of annual residential electricity use in the United States. According to UK's Energy Saving Trust, plasma TVs consume about four times more energy as that of the older cathode-ray TVs. Similarly, stereo systems are not power efficient. Conventional systems wastefully supply power to audio power amplifiers that may be wholly unused in certain modes of operation, and/or supply the same power supply and biasing levels to the amplifiers in each of the modes regardless of differences in the need for output power as a function of the selected mode.

### SUMMARY

An energy saving system includes a utility controller to transmit a signal for a demand response period or a peak energy price for a peak pricing period from a utility facility; and a display receiving the signal from the utility controller, the display having a first brightness mode operative during the demand response period or the peak pricing period, and a second brightness mode for other period.

### BRIEF DESCRIPTION OF THE DRAWINGS

FIG. 1A shows an exemplary smart grid home while FIG. 1B illustrates an exemplary smart home system.

FIG. 2 shows an exemplary motion detector.

FIG. 3 shows an exemplary PIR motion detector.

FIG. 4 shows an exemplary energy efficient entertainment system.

FIG. 5 shows an exemplary mesh network.

FIG. 6A shows an exemplary wrist-watch based assistance device.

FIG. 6B shows an exemplary phone based assistance device.

FIGS. 7A-7G shows an exemplary foldable cell phone/mobile computer that can be either a portfolio or a wallet.

FIG. 8 shows another wearable appliance.

### DESCRIPTION

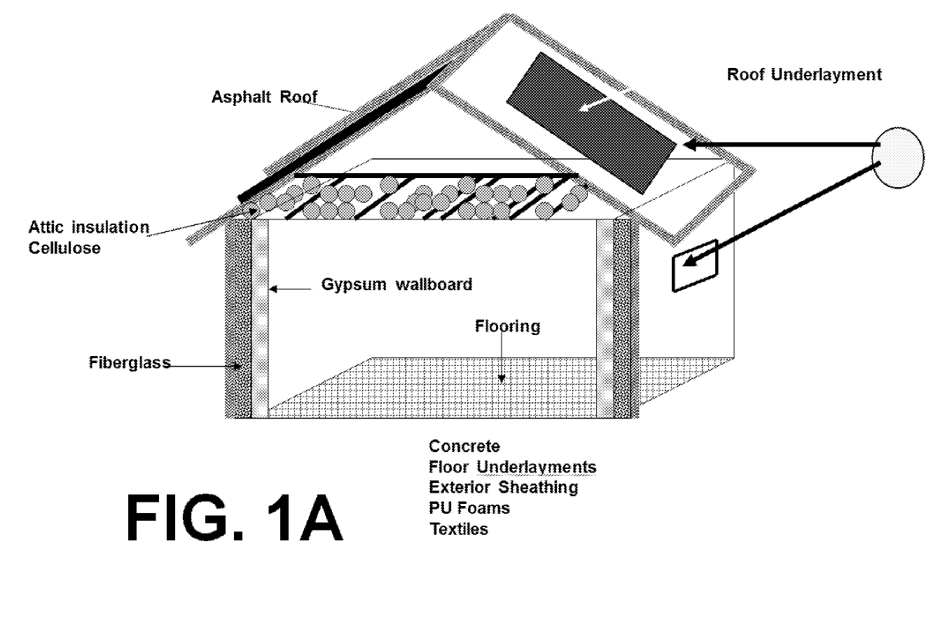

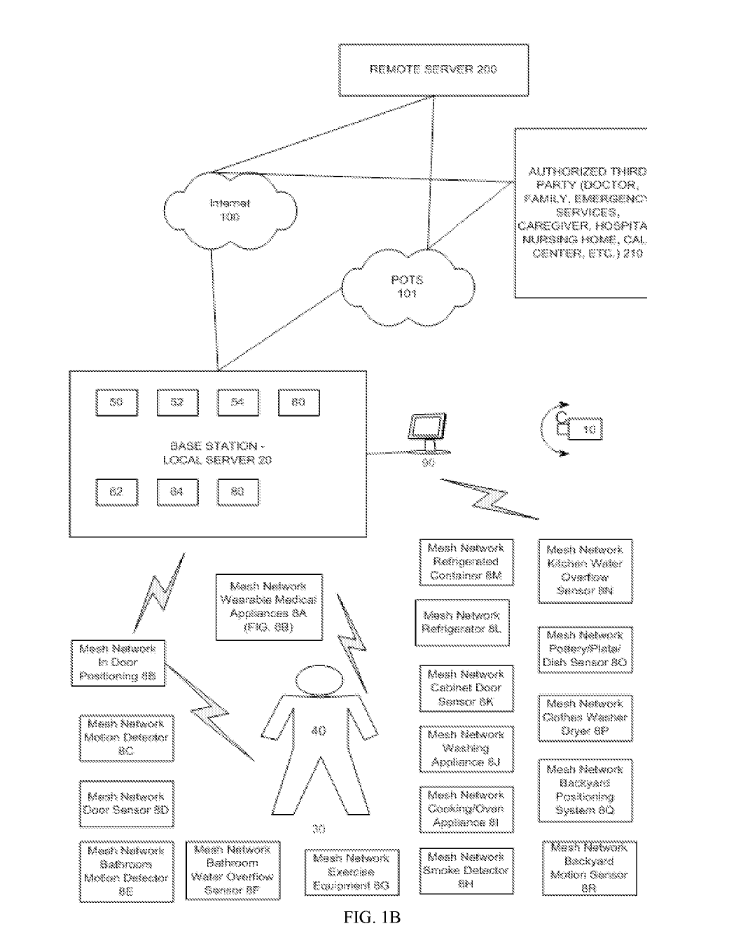

FIG. 1A shows an exemplary smart grid home. The smart grid home includes smart building materials such as smart tile ceiling/floor panels and windows/window shades, as discussed in depth below. In one embodiment, the home may include a roof refrigeration unit to store energy. Ice is one technical modality currently used in commercial building applications to store “coolth” at night by running refrigeration equipment. During the day, the refrigeration equipment is turned off to reduce peak electrical demand. To store heat (from the sun, for example), however, a different phase change material is needed. Alternatives to ice can be used. For example, paraffin, alone, and solid-state phase change materials (PCM) can be incorporated into building products such as wallboard and concrete. Microencapsulated PCM can be used in window cover or fabrics to reduce temperature fluctuations.

The windows allow sunlight or solar radiation into a building or structure when the ambient temperature is low and substantially block solar radiation when the ambient temperature is high, especially when sunlight is directly on the window. This house provides windows that allow passive solar heating and daylighting on colder days and still provide significant daylighting, while blocking solar heat build-up on warmer days, especially from sunlight shining directly on or through the windows of this invention. This house also provides thermochromic devices such as variable transmission shutters for use as lenses or filters.

Ultimately, it is the outdoor or ambient temperature and the directness of the sun's rays that determine the need for energy blocking character of windows. In a number of embodiments of this invention, the windows of this invention spontaneously change to provide energy blocking under the appropriate conditions of temperature and directness of sunlight without the control mechanisms and user intervention required by most alternate technologies under consideration for use as dimmable windows. Other embodiments of this invention provide windows that can be controlled by users or be controlled automatically by, for example, electronic control mechanisms, if so desired.

Windows have residual light energy absorbing character such that when exposed to sunlight, (especially direct sunlight on warm or hot days), the temperature of at least a portion of the total window structure is raised significantly above the ambient, outdoor temperature. The windows and devices combine thermochromic character with this residual light energy absorbing character, juxtaposed in such a manner that there is an increase in temperature of the materials responsible for the thermochromic character when there is an increase in temperature due to sunlight exposure of the materials responsible for the residual light energy absorbing character. The thermochromic character is such that the total light energy absorbed by the window increases as the temperature of the materials responsible for the thermochromic character is increased from the ambient, outdoor temperature to temperatures above the ambient, outdoor temperature.

The residual light energy absorbing character is provided by static light energy absorbing materials and/or thermochromic materials that have some light energy absorbing character at ambient, outdoor temperatures. Preferably, any light energy absorbing character of the thermochromic materials at ambient outdoor, temperatures that contributes to the residual light energy absorbing character is due to the more colored form of the thermochromic materials that exists because of the thermal equilibrium between the less colored and more colored forms at outdoor, ambient temperatures or is due to the coloration of the less colored form and is not due to photochromic activity of the thermochromic materials. Preferably, the residual light energy absorbing character is such that the window is capable of absorbing about 5% or more and more preferably about 10% or more of the energy of solar irradiance incident on the window or device apart from any absorption changes caused by sunlight exposure. Preferably, the residual light energy absorbing character is such that there is a temperature increase in the materials responsible for the thermochromic character of at least 10° C. and more preferably of at least 20° C. above the ambient, outdoor temperature when the window or device is exposed to direct or full sunlight.

The thermochromic character can be provided by essentially any material or materials which change reversibly from absorbing less light energy to absorbing more light energy as the temperature of the material or materials is increased. It is preferred that the thermochromic character be provided by materials that have a smaller absorption at outdoor, ambient temperatures on warm and hot days and have an increase in absorption when the temperature of the materials responsible for the thermochromic character is increased at least 10° C. It is preferred that the thermochromic character be provided by materials that have even less absorption at outdoor, ambient temperatures on cool and cold days and a less significant increase in absorption when the temperature of the window increases due to exposure to direct or full sunlight on cool and cold days.

The windows optionally combine other characteristics like low emissivity, infrared light reflectance, barrier properties, protective overcoating, multipane construction and/or special gas fills to provide energy efficient windows.

Energy efficient windows and devices of the invention can have one or more thermochromic layers which change from absorbing less light energy to absorbing more light energy as the temperature of the thermochromic layer(s) is increased. For many of the thermochromic layers used in the invention, this means a change from less colored to more colored as the temperature of the thermochromic layer(s) is increased.

Windows and devices of the invention can have one or more substrates, (i.e. window pane, panel, light or sheet). The substrate may be a thermochromic layer or the substrate may have thermochromic layer(s) provided thereon. Windows of the invention may comprise two or more substrates spaced apart by spaces containing gas or vacuum. Windows optionally include a barrier to short wavelength light. The short wavelength light may be ultraviolet (UV) light. The short wavelength light may, optionally, include short wavelength visible (SWV) light. The barrier may absorb some or all of the UV and/or SWV light incident on the barrier layer. The barrier may be a substrate, a portion of a substrate, (e.g., the barrier may be in a polymeric layer adhering two sheets of glass together), or the barrier may be a layer provided on a substrate. The barrier, if present, is located between the sun and the thermochromic layer and serves to protect and/or modify the behavior of the thermochromic layer and possibly other layers present. The barrier can protect other layers, for example, from photodegradation by UV light and can modify the behavior of the thermochromic layer by suppressing some or all of the photochromic character of materials present which have both thermochromic and photochromic character. In many cases, the thermochromic materials will be incorporated into a polymeric material which includes an additive such as a UV stabilizer. While this stabilizer does not ordinarily provide the equivalent effect of a barrier layer, devices have been constructed without a barrier layer when a UV stabilizer is present in the thermochromic layer.

Windows may have a protective overcoat. This overcoat, if present, serves to protect the thermochromic layer and optionally any other layer which may be present from, for example, physical abrasion, oxygen and environmental contaminants. The thermochromic layer is located between the sun and the protective overcoat, if it is present, e.g., a window pane of glass/ thermochromic layer/protective overcoat may be oriented with the overcoat on the inside surface of the window structure.

Windows may also have one or more static light energy absorbing materials. These materials provide relatively constant light energy absorption, (i.e. absorption which is not significantly dependent on the temperature or photochemical processes of the light energy absorbing material). The static light energy absorbing material(s), if present, serves to provide residual light energy absorbing character and thus absorbs enough light energy during direct or full sunlight exposure to raise the temperature of at least a portion of the window above the ambient temperature surrounding the window. This helps to make the windows responsive to the directness of the sunlight. The static light energy absorbing materials may be contained in a separate layer, in the substrate, and/or any of the other layers present including the thermochromic layer as long as the absorbed energy is able to warm the themochromic material to a temperature at which the thermochromic material increases in sunlight absorption. Windows may have one or more low emissivity, (low-e), layers. The low-e layer(s) helps provide energy efficiency by its ability to reflect infrared, (IR), light and/or its ability to poorly emit or radiate IR light. Using the thermochromic layers, the roof can turn white during summer days to reflect sunlight and minimize heat inside the house and can turn black during winter months to absorb heat to warm the house. The carpet can also have a multi-component PCM fibre, wherein a first fibre body consists of a first material comprising a phase change material and a second fibre body consists of a second material and encloses the first fibre body, wherein the phase change material is in raw form and the first material comprises a viscosity modifier selected from polyolefines having a density in the range of 890-970 kg/m 3 as measured at room temperature according to ISO 1183-2 and a melt flow rate in the range 0.1-60 g/10 minutes measured at 190° C. with 21.6 kg weight according to ISO 1133. The expression “raw form” is intended to mean that the PCM is introduced in its raw form at the manufacturing of the multi-component fibre, i.e. that the PCM is not encapsulated, the PCM is neither carried on or by another material solid at the spinneret temperature during spinning of the multi-component fibre, such as soaked into a porous structure, wherein the structure is solid at the spinneret temperature during spinning of the multi-component fibre. Thus, the PCM is considered as in “raw form” in spite of it being mixed with the viscosity modifier at manufacturing the multi-component fibre. Polymers having a melt flow rate in the range 0.1 to 60 g/10 minutes measured at 190° C. with 21.6 kg weight are suitable as viscosity modifiers in the multi-component fibre. Many of the efficient PCM materials are low molecular compounds and such compounds possess low viscosities at the relevant processing temperatures (180-300° C.). In order to make multi-component fibres with a sheath material, the second material, having a higher viscosity at the processing temperature, the inventors have now found that if the phase change material is mixed with a polyolefin having a melt flow rate in the range 0.1-60 g/10 minutes, a fibre having high latent heat and which is strong is obtained. The polyolefin is a viscosity modifier, which increases the viscosity of the first material of the multi-component fibre. A low amount of a viscosity modifier having a melt flow rate in the range 0.1-60 g/10 minutes may be used, which is an advantage for the thermal efficiency in terms of specific latent heat and at the same time allow the full utilisation of the inherent specific latent heat of melting/crystallisation of the phase change material. If a higher value than 60 g/10 minutes is used, the viscosity will be too low and the mixture will not be possible to process a fibre. The mixture will be “watery”, i.e. very thin. A value lower than 0.1 g/10 minutes of the viscosity modifier might lead to curling of the fibres and fibre spinning may not be possible.

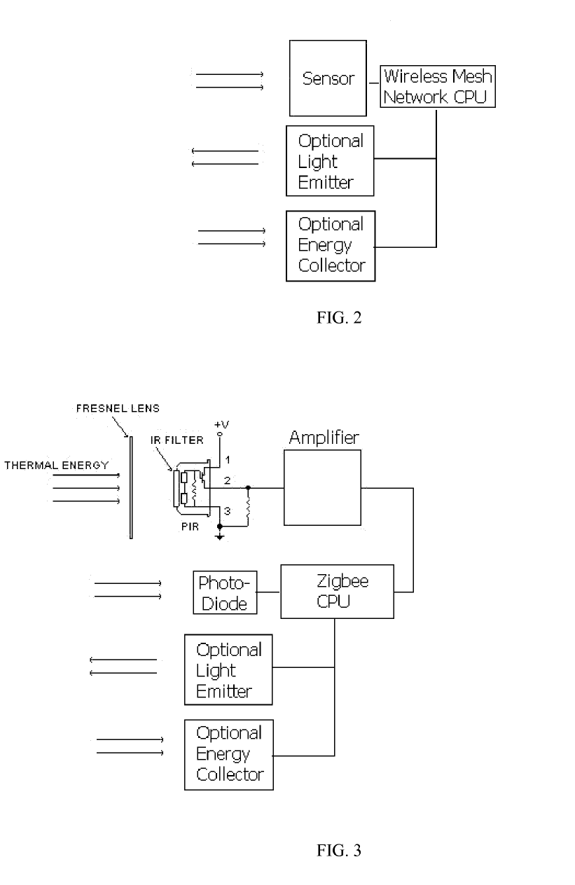

FIG. 2 shows an exemplary wireless network monitoring system. The system can operate in a home, a nursing home, or a hospital. In this system, one or more mesh network appliances 8 are provided to enable wireless communication in the home monitoring system. As shown in FIG. 2, a mesh network of sensors 8A-8R is shown. One implementation of mesh network is a ZigBee mesh network, which is discussed in more details in FIG. 5 below. ZigBee is built on an Institute of Electrical and Electronics Engineers (IEEE) global standard, 802.15.4, similar to the standards that govern Bluetooth and Wi-Fi. Open standards encourage innovation and competition, which bring down costs. Unlike Bluetooth and Wi-Fi networks, which require central hubs that distribute information to dispersed devices, ZigBee allows devices to form mesh networks, where each unit can relay information to its neighbors. Mesh networks are more robust than their hub-and-spoke counterparts; if a node breaks down, other nodes can automatically reroute transmissions around it. Mesh networking could let ZigBee systems link as many as 64,000 devices; Bluetooth networks, by contrast, are limited to just eight.

The mesh network includes one or more mesh network wearable medical appliances 8A which can monitor physiological measurements such as EKG, EMG, EEG, bioimpedance sensor, heart rate sensor, blood pressure sensor, or insulin sensor, among others. More details on these devices are described in commonly owned, co-pending applications that are incorporated by reference above. Appliances 8A in the mesh network can be one of multiple portable physiological transducer, such as a blood pressure monitor, heart rate monitor, weight scale, thermometer, spirometer, single or multiple lead electrocardiograph (ECG), a pulse oxymeter, a body fat monitor, a cholesterol monitor, a signal from a medicine cabinet, a signal from a drug container, a signal from a commonly used appliance such as a refrigerator/stove/oven/washer, or a signal from an exercise machine, such as a heart rate. As will be discussed in more detail below, one appliance is a patient monitoring device that can be worn by the patient and includes a single or bi-directional wireless communication link, generally identified by the bolt symbol in FIG. 1, for transmitting data from the appliances 8 to the local hub or receiving station or base station server 20 by way of a wireless radio frequency (RF) link using a proprietary or non-proprietary protocol.

The mesh network includes an in-door positioning 8B. The system has two or more wireless mesh network nodes that communicate with a mobile mesh network node. The radio signal strength indication (RSSI) is used to determine distance between two nodes, and triangulation is used to determine position. A localization process can be used to improve the position determination. In one embodiment, the mobile node periodically sends out packets containing RSSI and accelerometer data. The other two nodes receive the packets. After a packet is successfully received, RF signal strength RSSI reading is determined. The resulting signal strength measurements from the fixed sensing nodes are used to determine the wearer's location. Due to uncertainty associated with noisy data and the signal strength's nonlinearity, a probabilistic Monte Carlo localization technique to implement a particle filter to localize the location. Particle filters work by first distributing random samples called particles over the space being observed. Each particle represents a possible physical location in the environment. A probability value is assigned to each particle. This probability represents the likelihood that the person is at the location specified by the particle. At each time step, each particle is reevaluated and its probability value is updated according to the ZigBee signal strength measurements. Less likely particles are then redistributed around more likely particles. This is done by building a cumulative sum graph of the normalized probabilities of each particle. This graph is then randomly sampled to create a histogram that dictates where the particles should be distributed at the next time step. The particles concentrate around locations that have a higher probability of being the person's location. After the particles have their new coordinates, a small amount of random noise is added to each particle's location so that they're distributed around likely locations instead of concentrating at a single point. The location of the person resides at the intersection of two imaginary spheres centered at each of the sensing nodes, with radii proportional to the signal strength.

The in-door positioning system 8B links one or more mesh network appliances to provide location information. Inside the home or office, the radio frequency signals have negligible multipath delay spread (for timing purposes) over short distances. Hence, radio strength can be used as a basis for determining position. Alternatively, time of arrival can be used to determine position, or a combination of radio signal strength and time of arrival can be used. Position estimates can also be achieved in an embodiment by beamforming, a method that exchanges time-stamped raw data among the nodes. While the processing is relatively more costly, it yields processed data with a higher signal to noise ratio (SNR) for subsequent classification decisions, and enables estimates of angles of arrival for targets that are outside the convex hull of the participating sensors. Two such clusters of ZigBee nodes can then provide for triangulation of distant targets. Further, beamforming enables suppression of interfering sources, by placing nulls in the synthetic beam pattern in their directions. Another use of beamforming is in self-location of nodes when the positions of only a very small number of nodes or appliances are known such as those sensors nearest the wireless stations. In one implementation where each node knows the distances to its neighbors due to their positions, and some small fraction of the nodes (such as those nearest a PC with GPS) of the network know their true locations. As part of the network-building procedure, estimates of the locations of the nodes that lie within or near the convex hull of the nodes with known position can be quickly generated. To start, the shortest distance (multihop) paths are determined between each reference node. All nodes on this path are assigned a location that is the simple linear average of the two reference locations, as if the path were a straight line. A node which lies on the intersection of two such paths is assigned the average of the two indicated locations. All nodes that have been assigned locations now serve as references. The shortest paths among these new reference nodes are computed, assigning locations to all intermediate nodes as before, and continuing these iterations until no further nodes get assigned locations. This will not assign initial position estimates to all sensors. The remainder can be assigned locations based on pairwise averages of distances to the nearest four original reference nodes. Some consistency checks on location can be made using trigonometry and one further reference node to determine whether or not the node likely lies within the convex hull of the original four reference sensors.

In two dimensions, if two nodes have known locations, and the distances to a third node are known from the two nodes, then trigonometry can be used to precisely determine the location of the third node. Distances from another node can resolve any ambiguity. Similarly, simple geometry produces precise calculations in three dimensions given four reference nodes. But since the references may also have uncertainty, an alternative procedure is to perform a series of iterations where successive trigonometric calculations result only in a delta of movement in the position of the node. This process can determine locations of nodes outside the convex hull of the reference sensors. It is also amenable to averaging over the positions of all neighbors, since there will often be more neighbors than are strictly required to determine location. This will reduce the effects of distance measurement errors. Alternatively, the network can solve the complete set of equations of intersections of hyperbola as a least squares optimization problem.

In yet another embodiment, any or all of the nodes may include transducers for acoustic, infrared (IR), and radio frequency (RF) ranging. Therefore, the nodes have heterogeneous capabilities for ranging. The heterogeneous capabilities further include different margins of ranging error. Furthermore, the ranging system is re-used for sensing and communication functions. For example, wideband acoustic functionality is available for use in communicating, bistatic sensing, and ranging. Such heterogeneous capability of the sensors 40 can provide for ranging functionality in addition to communications functions. As one example, repeated use of the communications function improves position determination accuracy over time. Also, when the ranging and the timing are conducted together, they can be integrated in a self-organization protocol in order to reduce energy consumption. Moreover, information from several ranging sources is capable of being fused to provide improved accuracy and resistance to environmental variability. Each ranging means is exploited as a communication means, thereby providing improved robustness in the presence of noise and interference. Those skilled in the art will realize that there are many architectural possibilities, but allowing for heterogeneity from the outset is a component in many of the architectures.

A mesh network motion detector 8C can be used in the network. FIG. 2 shows an exemplary system that includes an active or passive motion sensor connected to a wireless mesh network processor. For certain applications such as night guide light, the wireless mesh network processor can control an optional light emitter such as a light bulb or LED array for evening lighting purposes when motion is detected. For ease of placement, the system can include an energy collector or harvester device such as a solar cell to power the entire system.

The motion sensors can be grouped into two categories. The first are passive devices, such as PIR systems, stereoscopic vision and swept-focus ranging systems. The second are active devices, such as laser, microwave and ultrasonic range finding systems.

In one embodiment, the sensor can be an ultrasonic ranging device such as a Polaroid ranging module. This device is an active time-of-flight device developed for their cameras to allow automatic camera focusing. It determines the range to a target by measuring elapsed time between the transmission of a “chirp” of pulses and a detected echo. The one millisecond chirp consists of four discrete frequencies composed of 8 cycles at 60 KHz, 8 cycles at 56 KHz, 16 cycles at 52.5 KHz, and 24 cycles at 49.41 KHz. This pulse train increases the probability of signal reflection from a wide range of targets.

In another embodiment, the motion sensor can be a radio detection and ranging (RADAR) K-Band microwave RF (radio frequency) transmitter whose signal gets reflected by the target person. The reflected signal will have a Doppler shift proportional to the target speed. This Doppler frequency shift is detected in the receiver, amplified, filtered, and then digitized in an analog-to-digital converter (ADC), and passed onto the digital signal processing (DSP) chip. The DSP chip filters out false and low-level return signals to identify the speed of the person. The speed, along with various statistics and averages, is then sent over the wireless mesh network. In one implementation, the sensor sends out high frequency (such as 24 GHz) radio waves and measures the difference between the signal it transmitted and the signal bounced back to it and relays this information to the DSP to determine the speed of the individual. In yet another embodiment, a microwave signal is used to detect motion.

FIG. 3 shows one implementation of a PIR motion sensor. A pyroelectric sensor is used with a crystalline material that generates a surface electric charge when exposed to heat in the form of infrared radiation. When the amount of radiation striking the crystal changes, the amount of charge also changes and can then be measured with a sensitive FET device built into the sensor. The sensor has two sensing elements connected in a voltage bucking configuration. This arrangement cancels signals caused by vibration, temperature changes and sunlight. A body passing in front of the sensor will activate first one and then the other element whereas other sources will affect both elements simultaneously and be cancelled. The radiation source must pass across the sensor in a horizontal direction when sensor pins 1 and 2 are on a horizontal plane so that the elements are sequentially exposed to the IR source. The FET source terminal pin 2 connects through a pulldown resistor of about 100 K to ground and feeds into a two stage amplifier having signal conditioning circuits. The amplifier is typically bandwidth limited to below 10 Hz to reject high frequency noise and is followed by a window comparator that responds to both the positive and negative transitions of the sensor output signal. A filtered power source of from 3 to 15 volts should be connected to the FET drain terminal pin 1. One exemplary device is the RE200B PIR sensor and an exemplary module is the QK76 PIR Motion Detector Module, available from Q Kits Ltd. Of Kingston Ontario, whose output is an active high pulse of approximately 0.5 seconds and remains active as long as there is motion. A focusing lens is used in front of the sensor to focus thermal energy. The output of the sensor is provided to an amplifier, which output is provided to a mesh network wireless chip such as a single chip ZigBee transceiver with processor available from Freescale or Texas Instrument(ChipCon). The ZigBee chip can receive data from a photodiode and control a light emitter (such as LED array or light bulb) to provide night lighting in one option. This embodiment can also optionally harvest solar energy to charge the device when light is available.

A combination of active and passive motion sensors can be used for the mesh network motion detector 8C. They inject energy (light, microwaves or sound) into the environment in order to detect a change. In one embodiment, a beam of light crosses the room near the door, and a photosensor on the other side of the room detects the beam. When a person breaks the beam, the photosensor detects the change in the amount of light and sends a signal over the mesh network. In another embodiment, a radar detects when someone passes near the door. The radar sends out a burst of microwave radio energy and waits for the reflected energy to bounce back. When a person moves into the field of microwave energy, it changes the amount of reflected energy or the time it takes for the reflection to arrive, and the radar sends a signal over the mesh network to indicate a person is crossing the zone and optionally opens the door. Similarly, an ultrasonic transducer can be used to send sound waves, bouncing them off a target and waiting for the echo.

Passive motion sensors can be used as well. In one embodiment, the motion sensing such as those on lights (and security systems) is a passive system that detects infrared energy. These sensors are known as PIR (passive infrared) detectors or pyroelectric sensors. The sensor is sensitive to the temperature of a human body which has a skin temperature of about 93 degrees F. and radiates infrared energy with a wavelength between 9 and 10 micrometers. Therefore, the sensors are typically sensitive in the range of 8 to 12 micrometers. The sensor can be a photo-sensor—the infrared light bumps electrons off a substrate, and the electrons are detected and amplified into a signal that is then sent over the mesh network to the controller. The sensor looks for a rapid change in the amount of infrared energy. When a person walks by, the amount of infrared energy in the field of view changes rapidly and is detected. The motion sensor can be a wide field of view by using suitable lens covering the sensor to focus and bend light through plastic lenses.

In a basic embodiment, a single motion sensor 8C can be placed between the bed of the user and the bathroom. In a case where only a door sensor 8D is provided within the system, the door sensor 8D can be placed on the door of the bathroom. Such basic configuration can determine whether the user being monitored has gotten out of bed or has gone to the bathroom after a predetermined time. The daily living activity is captured and the information is captured for pattern analysis by the base station 20. For example, the pattern analysis can determine if the user remains in bed a specified length of time beyond the usual waking time or has not gone from the bed to the bathroom for a predetermined time period. If an abnormal lack of user activity is determined, the system can request the third-party 210 to take preventive action. A status report can be sent to the third party 210 indicating a potential problem with the patient.

A mesh network door sensor 8D can transmit door opening/closing to the base station 20. The door sensor can be magnetic sensors, or can be a wire that complete a circuit when the door is closed, can be an optical beam that is interrupted when the door moves, a reed-switch that detects door movement, or can be any suitable method to detect door opening or closing. The system can also be applied to windows to detect window opening and closing.

A mesh network bathroom motion detector 8E is provided to detect motions within a specific room, in this case a bathroom. Room specific sensors such as a mesh network bathroom water overflow sensor 8F can be provided. In one embodiment, a pair of wires is positioned on the bathroom floor and when liquid shorts the wires, a signal is sent over the mesh network to indicate bathtub overflow problem. Other room specific sensors can include a toilet sensor (not shown). The toilet sensor can simply detect lid opening/closing operations. In another implementation, the toilet sensor can include piezoelectric sensors that sense the viscosity of the patient excrements. In yet other implementations, the toilet sensor includes temperature sensor or other chemical analyzers that determine the composition or indicators thereof and forward the information over the mesh network.

The system also receives information from mesh network enabled exercise equipment 8G. Data transmitted by the equipment can include the length of the exercise, the type of exercise, the calories burned, the distance exercised, and the heart rate, among others.

The system can receive information from mesh network smoke detector or fire alarm device 8H. In one embodiment, if the smoke detector 8H detects a fire, the smoke detector 8H can turn on the lights on the floor that guide the patient to safety.

The system can also monitor cooking related activities. In one embodiment, a kitchen motion sensor is used. A mesh network cooking or oven appliance 8I transmits cooking duration and temperature and other parameters to the base station 20 for monitoring in case the patient accidentally left the oven or cooking device on. A mesh network washing appliance 8J can provide washing duration and completion time to the base station 20. Further, a mesh network cabinet door sensor 8K can provide usage data for certain important items in a cabinet (such as medication, among others). A mesh network refrigerator 8L provides information such as opening/closing of the refrigerator and other useful data such as type and remaining quantity of items in a particular refrigerated container 8M. The kitchen can also incorporate a kitchen water overflow sensor 8N near the sink. A mesh network pottery/plate/dish sensor 8O can be used to monitor if the patient is using these items on a frequent basis.

When an oven/stove safety detector module or software on the base station 20 receives information indicating that the oven or stove is on from sensor 8I, the system determines whether the oven or stove should be turned off. For example, if the patient is sleeping on a bed or sofa and the oven is on for an extended period of time, the base station 20 can instruct the mesh network oven appliance 8I to reduce the heat and page the patient. If the patient answers the page, the system can display the oven condition and request patient instruction. If the patient does not respond or respond with instruction to turn off the oven, the base station 20 can instruct the appliance 8I to turn off the oven. The system can also receive data from a cloth washer/dryer 8P to determine usage.

For the backyard, a mesh network positioning system 8Q can be used. Additionally, a backyard motion sensor 8R can communicate data over the mesh network for security as well as safety monitoring purposes.

In one heterogeneous sensor network embodiment, ZigBee nodes are used for local data communication, and high through put WiFi nodes are used to improve sensor network performance and reduce the nodes' energy consumption by offloading some of the wireless responsibilities to devices that can be plugged into power sources. The structure is analogous to a highway overlaid on a roadway system. Sensor data can then enter and exit the 802.11 highway at multiple interchanges in order to bypass the side roads, the wireless ZigBee nodes to increase bandwidth and reduce energy on average because the nodes are not solely responsible for moving data through the network.

Other appliances can be a bed spread or couch cover that includes a pressure transducer to detect a person sitting on the bed or couch. Another embodiment uses a simple contact switch that is depressed when the person sits on the bed or couch. The device can also be placed under chairs to detect sitting at a table. The pressure transducer or contact switch is connected to a mesh network processor/transceiver to transmit each occurrence when the user sits on a chair or rests on the bed. Based on the contact switch(es), the system can determine how long the user lies on the bed, and based on EEG sensors on the sheet, the system can determine how long the user sleeps and the quality of the sleep.

In another embodiment, a pressure transducer can be provided on a chair that measure the user's weight each time he or she uses the chair. Similarly, a bed transducer or scale can be provided to capture the user's weight and transmit the weight data over the mesh network. For a bed scale, two beam shaped load cells are provided at two ends of the bed along with support bars. The total weight is thus distributed over these two beams. The beam shaped load cell has a deflectable beam portion. Strain transducers for measuring deflection of the beam portion are located inside the beam portion. The strain transducer communicates its portion of the total weight to the mesh network weight processor. The bed scale is adjusted to compensate for the weight of the bed and the mattress. When the individual rests on the bed, the total weight is taken and the empty weight of the bed and mattress is subtracted to arrive at the weight of the individual person. Similarly, for a chair scale, each leg of the chair rests on a load cell with a deflectable beam portion. The total weight is thus distributed over the four leg beams. The beam shaped load cell has a deflectable beam portion. Strain transducers for measuring deflection of the beam portion are located inside the beam portion. The strain transducer communicates its portion of the total weight to the mesh network weight processor. The chair scale is adjusted to compensate for the weight of the chair. When the individual sits on the chair, the total weight is taken and the empty weight of the chair is subtracted to arrive at the weight of the individual person.

In another embodiment, a temperature sensor can be provided on the chair, sofa, couch, or bed to detect the temperature of the patient and transmit the information over the mesh network.

In another embodiment, ZigBee sensors are placed along with light switches. When the user turns on the light in a room, the activity is recorded along with the coordinate of the switch. Such fixed location information is useful in fine tuning or recalibrating the in-door position sensor 8B. The light switches can be powered by an energy harvester such as a piezoelectric device that is energized by the flip of the switch. Alternatively, solar cell can be used to power the circuitry associated with the switches.

In another embodiment, sensors can be placed on the stairs to determine the stair climbing pace of the user and track his/her performance to detect if there are cardiovascular problems. For example, stroke victims can take longer to climb a stair case. In one embodiment, a light sensor and a light beam can be placed at the top and bottom of a stair case and when the beam is interrupted, the system can record the time required to go up-stair or down-stair.

The mesh network also covers entertainment devices such as ZigBee enabled televisions and stereo equipment. Thus, the type of entertainment enjoyed by the patient can also be monitored by the mesh network. Interactive TV responses or alternatively TV channel flipping/switching can be monitored by system to sense the alertness of the user. If the user turns on the TV, but shows no motion for an extended period of time, this can be viewed as potential stroke problem where the viewer is extremely passive when he/she normally is much more active.

Appliances 8A-8R in the mesh network can include home security monitoring devices, door alarm, window alarm, home temperature control devices, fire alarm devices, among others. For example, within a house, a user may have mesh network appliances that detect window and door contacts, smoke detectors and motion sensors, video cameras, key chain control, temperature monitors, CO and other gas detectors, vibration sensors, and others. A user may have flood sensors and other detectors on a boat. An individual, such as an ill or elderly grandparent, may have access to a panic transmitter or other alarm transmitter. Other sensors and/or detectors may also be included. The user may register these appliances on a central security network by entering the identification code for each registered appliance/device and/or system. The mesh network can be Zigbee network or 802.15.4 network. More details of the mesh network is shown in FIG. 5 and discussed in more detail below.

The system can be used to monitor and assist elderly persons, functionally impaired persons or the like on a temporary short-term basis or on a long-term basis. The base station 20 is linked to various mesh network sensors provided within a number of activity detectors 8A-8R. Activity detectors 8A-8R monitor various activities of daily living of the user of the monitoring system. The base station 20 has a DAA to interface a voice communication circuit to the POTS 101 so that the user can wirelessly communicate with the authorized third party such as a call center without having to walk to a speaker phone. The base station 20 can also store voicemail and other messages such as pill reminder messages and play the messages for the user.

The patient monitoring system integrates sensor data from different activity domains to make a number of determinations at predetermined times on a twenty-four hour basis. One activity domain determination within the patient monitoring system includes movement of the person being monitored. In this movement domain determinations are made by the in-door position sensor 8B and/or the motion detector 8C to determine whether the user is up and around. Another activity domain determination is medication compliance where the system determines whether the user is following a predetermined medication regimen by detecting pill unit opening or closure. The system can also monitor dangerous conditions such as to whether a cooking range or stove has been left on inappropriately by querying mesh network controllers in the cooking range, stove, or cooking appliance. Other systems may include, for example, other potentially harmful appliances such as heaters, irons or electric space heaters.

The system of sensors the patient monitoring system can determine, for example, whether users are up and about in their homes and whether they are having difficulty managing their medications. It can also be determined whether the user has accidentally left a stove on or has failed to get out of bed a predetermined number of hours after a usual waking time. If the patient monitoring system detects any of these or other problems it can then first page the user on the wearable device such as wrist watch to provide a reminder about the medications, stove, or other detected problems. If the patient does not respond, the system elevates the issue to the authorized third party 210.

The system can track the activities of the patient and distribute specialized gerontological daily activity summary reports to users, family members, case managers, physicians and others. It also makes it possible to collect and act upon the designated priority information which may indicate immediate problems for the user. The system can generate periodic reports which may include collections, compilations and arrangements of information on any or all of the monitored activities within the user's living area. These electronic records may be used in combination with any other information to produce any type of periodic activity reports desired on the user being monitored. These user activity reports may be used by a professional case manager or a designated family member to determine if the user is experiencing problems with specific activities of daily living. Thus these problems may be dealt with before they become a threat to the continued well being of the user and the ability of the user to live independently. Furthermore, in addition to providing remote case monitoring and in-home reminders, the patient monitoring system may be programmed to take corrective actions when certain problems are detected. A social worker, health professional or designated family member can query the base station 20 or can respond to the transmitted information according to a predetermined protocol.

The system can provide case management that may monitor approximately a plurality of distributed clients. The system can receive information from the distributed patient monitoring systems on an immediate basis or at predetermined time intervals. For example, the remote case monitoring system may receive information on an hourly, daily or weekly basis. If the patient's local base station 20 determines that a potential problem exists, the base station 20 forwards the request to the server 200 running the case management software, and this event may be brought to the immediate attention of the human case monitor at a call center, for example, by means of a computer screen. The remote case manager may examine individual case and data records for the client being monitored to learn the predetermined response for the monitored person when the reported event occurs. Likely interventions required of personnel at the case management site may include calling a local case manager, a hospital social worker or a local next of kin. Other actions the remote case monitor may execute include calling the user, remotely downloading the last twenty-four or forty-eight hours worth of event summary information from the local patient monitoring system and remotely initiating a diagnostic sequence on the local patient monitoring system. The protocol of procedures for intervention by the remote case monitor may differ from one remote case monitor system to another and from one user to another. It is anticipated in the preferred embodiment of the invention that various intervention decisions such as who to call when predetermined events occur and what messages to deliver may be carried out by a machine intelligence expert system (not shown) at the remote case monitoring system or by a person or a combination of both. The local patient monitoring system may also be programmed to carry out such decisions as who to call when appropriate. For example, the patient monitoring system may have a contact list of people to contact in various emergencies. In addition to receiving and interpreting data indicating the need for intervention in event of emergencies, the remote case monitoring software on the server 200 routinely receives downloaded data from individual patient monitoring systems 20 at predetermined intervals. This data is interpreted on the individual and aggregate level by means of trend analysis software which detects larger than statistically normal deviations from event pattern measurements. The remote case monitoring system on the server 200 may use this analysis to produce periodic summary reports of events relating to everyday living tasks in the home environment of the user. More specifically these reports may be used to detect certain event classes, to weight them in terms of their relative importance and to compare them with baselines of task performance. The events weighed with respect to their importance may include getting out of bed, managing medication, the proper control of a stove, the proper control of water flow, and the proper control of selected electrical appliances. Based upon the reports of these events, gerontological living summary reports may be prepared in machine form and paper form at the remote case management software for distribution to predesignated parties involved in the case management of the patient. These parties may include the users themselves, relatives of the user, case manager social workers, physicians and other appropriate formal and informal providers. The system can produce trend analysis reports which show the frequency of occurrence of different events over a predetermined time period such as six months. Thus the trend analysis report might show that over the course of six months the user became increasingly noncompliant with medications and/or increasingly likely to leave the stove on inappropriately. Using a known trend analysis technique, software driven reports can detect increasing frequencies of problems of every day activities. The trend analysis report may be a monthly paper or machine report which provides several indicators of performance on different areas of everyday living monitored by the patient monitoring system. These areas may include waking and sleeping, medication management, stove management, water flow management and the operation of additional appliances. The raw data for this report is based on the event log data transferred from the base station 20 or the server 200 using standard data transfer and priority specific modes. The trend analysis report can plot deviations in behavior indicating changes in plot trend. For example, the trend analysis report can plot waking and sleeping hours and the number of times a user goes to the bathroom. While none of this in itself indicates a situation requiring intervention, sudden changes in sleep habits, bathroom use, even appliance use may indicate sudden changes in health or cognitive well being requiring a relative or a case management social worker or case management social worker or a physician to visit or interview the user. While any number of combinations of interpreted data can be used in any number of specialized reports, it is anticipated that most case management sites and most relatives would want to know the frequency and severity of specific errors, the extent and accuracy of medication compliance and whether a waking or sleeping pattern of a user is changing radically. The trend analysis report provides case managers and relatives with this information and enables them to better help the user by locating subtle changes in behavior patterns, monitoring various kinds of potentially dangerous errors and keeping a record of baseline functioning in relation to monitored activities.

For patients whose safety concerns outweigh privacy issue, a plurality of monitoring cameras 10 may optionally be placed in various predetermined positions in a home of a patient 30. The cameras 10 can be wired or wireless. For example, the cameras can communicate over infrared links or over radio links conforming to the 802X (e.g. 802.11A, 802.11B, 802.11G, 802.15) standard or the Bluetooth standard to a base station/server 20 may communicate over various communication links, such as a direct connection, such a serial connection, USB connection, Firewire connection or may be optically based, such as infrared or wireless based, for example, home RF, IEEE standard 802.11a/b, Bluetooth or the like. In one embodiment, appliances 8 monitor the patient and activates the camera 10 to capture and transmit video to an authorized third party for providing assistance should the appliance 8 detects that the user needs assistance or that an emergency had occurred.

The base station/server 20 stores the patient's ambulation pattern and vital parameters and can be accessed by the patient's family members (sons/daughters), physicians, caretakers, nurses, hospitals, and elderly community. The base station/server 20 may communicate with the remote server 200 by DSL, T-1 connection over a private communication network or a public information network, such as the Internet 100, among others.

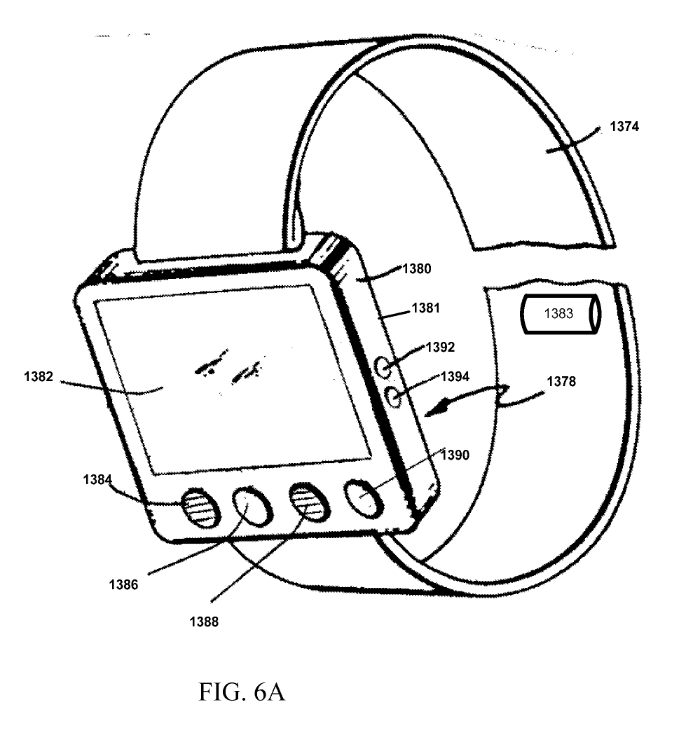

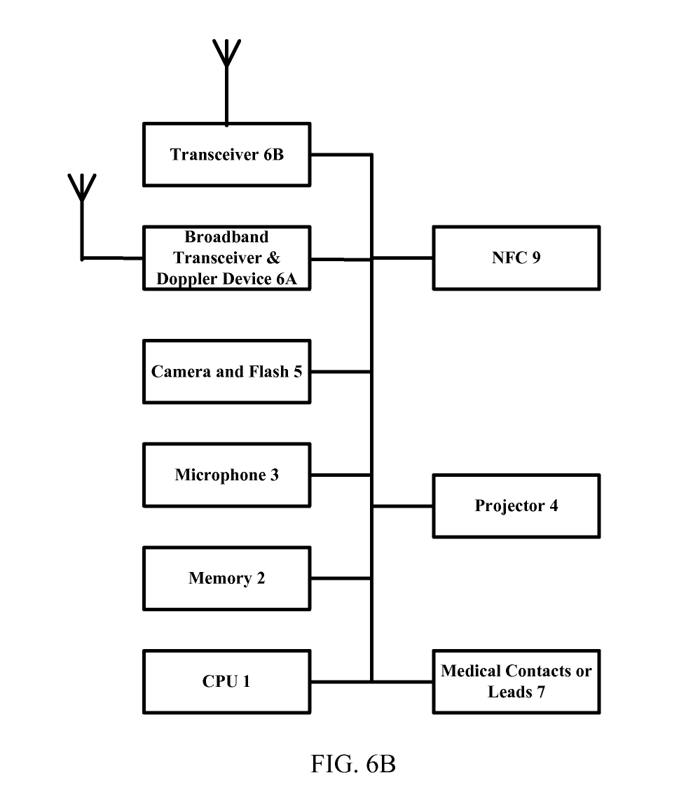

The patient 30 may wear one or more wearable patient monitoring appliances such as wrist-watches or clip on devices or electronic jewelry to monitor the patient. One wearable appliance such as a cell phone (FIG. 6B) or a wrist-watch (FIG. 6A) that includes sensors 40, for example devices for sensing ECG, EKG, blood pressure, sugar level, among others. In one embodiment, the sensors 40 are mounted on the patient's wrist (such as a wristwatch sensor) and other convenient anatomical locations.

Exemplary sensors 40 include standard medical diagnostics for detecting the body's electrical signals emanating from muscles (EMG and EOG) and brain (EEG) and cardiovascular system (ECG). Leg sensors can include piezoelectric accelerometers designed to give qualitative assessment of limb movement. Additionally, thoracic and abdominal bands used to measure expansion and contraction of the thorax and abdomen respectively. A small sensor can be mounted on the subject's finger in order to detect blood-oxygen levels and pulse rate. Additionally, a microphone can be attached to throat and used in sleep diagnostic recordings for detecting breathing and other noise. One or more position sensors can be used for detecting orientation of body (lying on left side, right side or back) during sleep diagnostic recordings. Each of sensors 40 can individually transmit data to the server 20 using wired or wireless transmission. Alternatively, all sensors 40 can be fed through a common bus into a single transceiver for wired or wireless transmission. The transmission can be done using a magnetic medium such as a floppy disk or a flash memory card, or can be done using infrared or radio network link, among others. The sensor 40 can also include an indoor positioning system or alternatively a global position system (GPS) receiver that relays the position and ambulatory patterns of the patient to the server 20 for mobility tracking.

In one embodiment, the sensors 40 for monitoring vital signs are enclosed in a wrist-watch sized case supported on a wrist band. The sensors can be attached to the back of the case. For example, in one embodiment, Cygnus' AutoSensor (Redwood City, Calif.) is used as a glucose sensor. A low electric current pulls glucose through the skin. Glucose is accumulated in two gel collection discs in the AutoSensor. The AutoSensor measures the glucose and a reading is displayed by the watch.

In another embodiment, EKG/ECG contact points are positioned on the back of the wrist-watch case. In yet another embodiment that provides continuous, beat-to-beat wrist arterial pulse rate measurements, a pressure sensor is housed in a casing with a ‘free-floating’ plunger as the sensor applanates the radial artery. A strap provides a constant force for effective applanation and ensuring the position of the sensor housing to remain constant after any wrist movements. The change in the electrical signals due to change in pressure is detected as a result of the piezoresistive nature of the sensor are then analyzed to arrive at various arterial pressure, systolic pressure, diastolic pressure, time indices, and other blood pressure parameters.

The case may be of a number of variations of shape but can be conveniently made a rectangular, approaching a box-like configuration. The wrist-band can be an expansion band or a wristwatch strap of plastic, leather or woven material. The wrist-band further contains an antenna for transmitting or receiving radio frequency signals. The wristband and the antenna inside the band are mechanically coupled to the top and bottom sides of the wrist-watch housing. Further, the antenna is electrically coupled to a radio frequency transmitter and receiver for wireless communications with another computer or another user. Although a wrist-band is disclosed, a number of substitutes may be used, including a belt, a ring holder, a brace, or a bracelet, among other suitable substitutes known to one skilled in the art. The housing contains the processor and associated peripherals to provide the human-machine interface. A display is located on the front section of the housing. A speaker, a microphone, and a plurality of push-button switches and are also located on the front section of housing. An infrared LED transmitter and an infrared LED receiver are positioned on the right side of housing to enable the watch to communicate with another computer using infrared transmission.

In another embodiment, the sensors 40 are mounted on the patient's clothing. For example, sensors can be woven into a single-piece garment (an undershirt) on a weaving machine. A plastic optical fiber can be integrated into the structure during the fabric production process without any discontinuities at the armhole or the seams. An interconnection technology transmits information from (and to) sensors mounted at any location on the body thus creating a flexible “bus” structure. T-Connectors—similar to “button clips” used in clothing—are attached to the fibers that serve as a data bus to carry the information from the sensors (e.g., EKG sensors) on the body. The sensors will plug into these connectors and at the other end similar T-Connectors will be used to transmit the information to monitoring equipment or personal status monitor. Since shapes and sizes of humans will be different, sensors can be positioned on the right locations for all patients and without any constraints being imposed by the clothing. Moreover, the clothing can be laundered without any damage to the sensors themselves. In addition to the fiber optic and specialty fibers that serve as sensors and data bus to carry sensory information from the wearer to the monitoring devices, sensors for monitoring the respiration rate can be integrated into the structure.

In another embodiment, instead of being mounted on the patient, the sensors can be mounted on fixed surfaces such as walls or tables, for example. One such sensor is a motion detector. Another sensor is a proximity sensor. The fixed sensors can operate alone or in conjunction with the cameras 10. In one embodiment where the motion detector operates with the cameras 10, the motion detector can be used to trigger camera recording. Thus, as long as motion is sensed, images from the cameras 10 are not saved. However, when motion is not detected, the images are stored and an alarm may be generated. In another embodiment where the motion detector operates stand alone, when no motion is sensed, the system generates an alarm.

The server 20 also executes one or more software modules to analyze data from the patient. A module 50 monitors the patient's vital signs such as ECG/EKG and generates warnings should problems occur. In this module, vital signs can be collected and communicated to the server 20 using wired or wireless transmitters. In one embodiment, the server 20 feeds the data to a statistical analyzer such as a neural network which has been trained to flag potentially dangerous conditions. The neural network can be a back-propagation neural network, for example. In this embodiment, the statistical analyzer is trained with training data where certain signals are determined to be undesirable for the patient, given his age, weight, and physical limitations, among others. For example, the patient's glucose level should be within a well established range, and any value outside of this range is flagged by the statistical analyzer as a dangerous condition. As used herein, the dangerous condition can be specified as an event or a pattern that can cause physiological or psychological damage to the patient. Moreover, interactions between different vital signals can be accounted for so that the statistical analyzer can take into consideration instances where individually the vital signs are acceptable, but in certain combinations, the vital signs can indicate potentially dangerous conditions. Once trained, the data received by the server 20 can be appropriately scaled and processed by the statistical analyzer. In addition to statistical analyzers, the server 20 can process vital signs using rule-based inference engines, fuzzy logic, as well as conventional if-then logic. Additionally, the server can process vital signs using Hidden Markov Models (HMMs), dynamic time warping, or template matching, among others. In the HMM embodiment, user activities are automatically classified and any variance from the usual pattern is flagged for monitoring by the authorized third party 210. In another embodiment, a Bayesian network is used to analyze and automatically build user ambulatory patterns to check if the user is not acting “normally.”

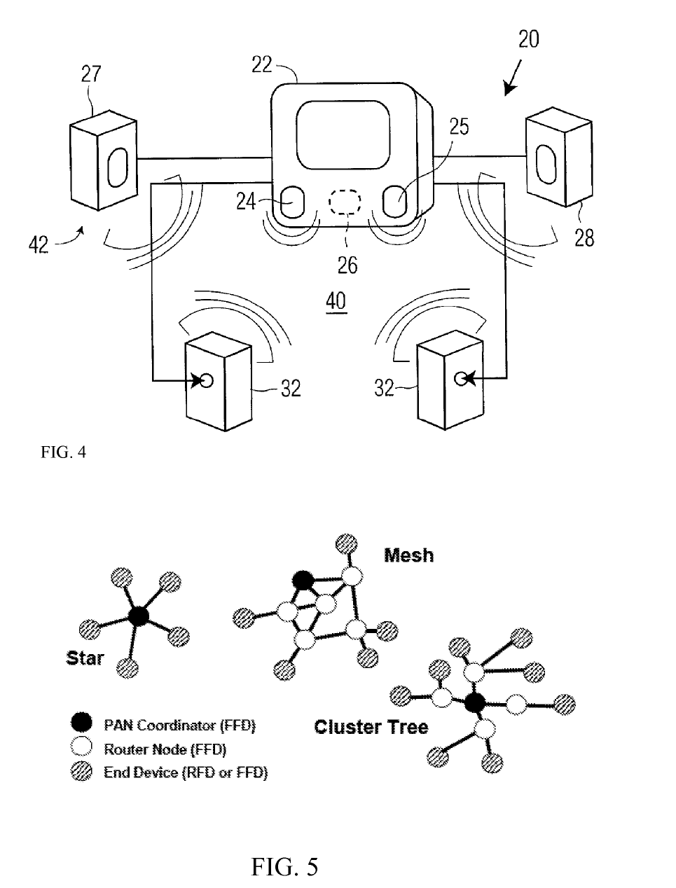

FIG. 4 shows an exemplary entertainment system that is compatible with a smart power grid. In this embodiment, a large screen display 10 such as a large screen TV receives video and audio from an AV receiver 20, which in turn selects outputs from a DVD player 12, a digital satellite receiver or a cable receiver 14, and a VCR 16, among others. The AV receiver 20 in turn provides audio/video signals to the display 10 and also built-in cabinet speakers. In a preferred embodiment, monaural programming is routed to the left and right cabinet speakers which in that mode present the same signal. Stereo is presented using the left and right speakers in the TV enclosure. The TV speakers may be driven by signals that are the result of processing the separated left and right stereo signals to provide the sensation of an audio source situated in the area of the front built-in speakers, but presented in an auditorium or large space wherein acoustic paths would cause phasing and echo effects similar to those provided as a result of the processing. The AV receiver 20 of the entertainment system drives additional external speakers such as front center speaker 22 and left/right front speakers 24A/24B, left surround speaker 26A, right surround speaker 26B, and rear surround speaker 28, for example.

The exemplary home entertainment system is generally provided in a display cabinet 22 having built-in audio speakers, such as a center speaker with left/right speakers. During a low power period, the speakers in the cabinet 22 will be used while the external speakers are powered down to save energy. The system includes external front speakers 24A and 24B driven by an AV amplifier 20.

The home entertainment system enables energy saving system with a utility controller to transmit a signal for a demand response period or a peak energy price for a peak pricing period from a utility facility; a display receiving the signal from the utility controller, the display having a first brightness mode operative during the demand response signal or the peak pricing period, and a second brightness mode for non-peak pricing period; and an audio video (AV) receiver coupled to the utility controller, the AV receiver including one or more audio amplifiers to drive external speakers, the audio amplifiers being disabled or turned off during the demand response signal or peak pricing period.

A mobile device can substitute for the power consuming entertainment system when needed. With a mobile device, the display and AV receiver are turned off during the demand response period or peak pricing period and AV output is rendered on the mobile device. A user override mode is provided to ignore the utility demand response signal. The display and the AV amplifiers are disabled or turned off in response to the demand response signal. The AV receiver provides power to one or more audio appliances, wherein the AV appliance comprises a video player, a disc player, a DVD player, a Blu-ray player, a cable box, a digital satellite receiver, a set-top box, a videocassette recorder, a streaming video device. One or more AV appliances each having a power supply coupled to the utility controller, wherein the power supply of each AV appliance is disabled or turned off during the peak pricing period, wherein the AV appliance is selected from a group consisting of: a video player, a disc player, a DVD player, a Blu-ray player, a cable box, a digital satellite receiver, a set-top box, a videocassette recorder, and a streaming video device. The display includes a first energy meter to determine energy consumption by the display and wherein the AV receiver comprises a second energy meter to determine energy consumption by the AV amplifier. A price display can show an energy cost of the entertainment system based on time of use (TOU) pricing. An incentive system can be connected to the utility controller to motivate compliance with a demand response request from the utility facility. The utility controller controls the display based on total household demand during a demand response period.

The energy saving entertainment system can include a utility controller utility controller to transmit a signal for a demand response period or a peak energy price for a peak pricing period from a utility facility; and an audio video (AV) receiver coupled to the utility controller, the AV receiver including one or more audio amplifiers to drive external speakers, the audio amplifiers being disabled or turned off during the peak pricing period.

By lowering the brightness setting, the system saves energy. This can save much energy during a brown out period given that TVs, especially plasmas and HDTVs, have their settings initially attuned for display in shops, where they need to be flashy and dazzling.

The system of FIG. 1B enables a smart home in that it automatically tracks user habits and adjusts to the user habits. One embodiment tracks elderly patients in the home. A pseudo-code for one embodiment of a pattern recognizer to assist the patient is as follows:

Build pattern of daily activities

Do
Detect if the user's daily activities are within a predetermined threshold of normal activities
Check that medication cabinet has been accessed on daily basis
Check door/window is closed in the evening unless specified in advance
Check that bathroom is not flooded
Check that patient is not in bathroom for excessive amounts of time
Check patient toilet for potential disease
Check for normal usage of exercise equipment in accordance with doctor recommendations
Check kitchen appliances to minimize risks of fire or flooding hazard
Check cloth washer/dryer for usage activity
Check refrigerator activity
Check backyard motion sensor for intrusion and/or assistance that may be required if the user is injured in the backyard
Check thermostat and heater/AC for temperature setting
Check sleeping activities
Check eating activities
Check weight
Check TV viewing or radio listening or computer usage habit
Check traversing speed on stair
If abnormality is detected, request assistance from authorized third party
Update daily activity data structure
Generate periodic summary/report/recommendations to person and authorized third parties

Loop

Through various software modules 50-80, the system monitors the behavioral patterns of the patient and can intervene if necessary. For example, the system can detect that the oven is on for an excessive amount of time and can turn off the oven using commands communicated over the mesh network. Authorized users 210 can see a display of the patient's activities on the screen using data securely transmitted over the Internet from the base station 20.

FIG. 6A shows a portable mobile phone housed in a wrist-watch. As shown in FIG. 6A, the device includes a wrist-watch sized case 1380 supported on a wrist band 1374. The case 1380 may be of a number of variations of shape but can be conveniently made a rectangular, approaching a box-like configuration. The wrist-band 1374 can be an expansion band or a wristwatch strap of plastic, leather or woven material. The processor or CPU of the wearable appliance is connected to a radio frequency (RF) transmitter/receiver (such as a cellular transceiver, a Bluetooth device, a Zigbee device, a WiFi device, a WiMAX device, or an 802.X transceiver, among others).

In one embodiment, the back of the device is a conductive metal electrode 1381 that in conjunction with a second electrode 1383 mounted on the wrist band 1374, enables differential EKG or ECG to be measured. The electrical signal derived from the electrodes is typically 1 mV peak-peak. In one embodiment where only one electrode 1381 or 1383 is available, an amplification of about 1000 is necessary to render this signal usable for heart rate detection. In the embodiment with electrodes 1381 and 1383 available, a differential amplifier is used to take advantage of the identical common mode signals from the EKG contact points, the common mode noise is automatically cancelled out using a matched differential amplifier. In one embodiment, the differential amplifier is a Texas Instruments INA321 instrumentation amplifier that has matched and balanced integrated gain resistors. This device is specified to operate with a minimum of 2.7V single rail power supply. The INA321 provides a fixed amplification of 5× for the EKG signal. With its CMRR specification of 94 dB extended up to 3 KHz the INA321 rejects the common mode noise signals including the line frequency and its harmonics. The quiescent current of the INA321 is 40 mA and the shut down mode current is less than 1 mA. The amplified EKG signal is internally fed to the on chip analog to digital converter. The ADC samples the EKG signal with a sampling frequency of 512 Hz. Precise sampling period is achieved by triggering the ADC conversions with a timer that is clocked from a 32.768 kHz low frequency crystal oscillator. The sampled EKG waveform contains some amount of super imposed line frequency content. This line frequency noise is removed by digitally filtering the samples. In one implementation, a 17-tap low pass FIR filter with pass band upper frequency of 6 Hz and stop band lower frequency of 30 Hz is implemented in this application. The filter coefficients are scaled to compensate the filter attenuation and provide additional gain for the EKG signal at the filter output. This adds up to a total amplification factor of greater than 1000× for the EKG signal.

The wrist band 1374 can also contain other electrical devices such as ultrasound transducer, optical transducer or electromagnetic sensors, among others. In one embodiment, the transducer is an ultrasonic transducer that generates and transmits an acoustic wave upon command from the CPU during one period and listens to the echo returns during a subsequent period. In use, the transmitted bursts of sonic energy are scattered by red blood cells flowing through the subject's radial artery, and a portion of the scattered energy is directed back toward the ultrasonic transducer 84. The time required for the return energy to reach the ultrasonic transducer varies according to the speed of sound in the tissue and according to the depth of the artery. Typical transit times are in the range of 6 to 7 microseconds. The ultrasonic transducer is used to receive the reflected ultrasound energy during the dead times between the successive transmitted bursts. The frequency of the ultrasonic transducer's transmit signal will differ from that of the return signal, because the scattering red blood cells within the radial artery are moving. Thus, the return signal, effectively, is frequency modulated by the blood flow velocity.

FIG. 6B shows an exemplary portable data-processing device that can be housed in the wristwatch or a mobile phone. In one embodiment, the device has a processor 1 connected to a memory array 2 such as flash memory that can also serve as a solid state disk. The processor 1 is also connected to a light projector 4, a microphone 3 and a camera/flash combination 5. The device also includes a near field communication (NFC) device 9 that can support mobile electronic commerce, among others. A wireless broadband transceiver 6A may be connected to the processor 1 to communicate with remote devices. For example, the wireless transceiver can be WiFi, WiMax, 802.X, Bluetooth, infra-red. A cellular transceiver 6B provides 4G cellular capability to the device.

The light projector 4 includes a light source such as a white light emitting diode (LED) or a semiconductor laser device or an incandescent lamp emitting a beam of light through a focusing lens to be projected onto a viewing screen. The beam of light can reflect or go through an image forming device such as a liquid crystal display (LCD) so that the light source beams light through the LCD to be projected onto a viewing screen. Alternatively, the light projector 4 can be a MEMS device. In one implementation, the MEMS device can be a digital micro-mirror device (DMD) available from Texas Instruments, Inc., among others. The DMD includes a large number of micro-mirrors arranged in a matrix on a silicon substrate, each micro-mirror being substantially of square having a side of about 16 microns.

Another MEMS device is the grating light valve (GLV). The GLV device consists of tiny reflective ribbons mounted over a silicon chip. The ribbons are suspended over the chip with a small air gap in between. When voltage is applied below a ribbon, the ribbon moves toward the chip by a fraction of the wavelength of the illuminating light and the deformed ribbons form a diffraction grating, and the various orders of light can be combined to form the pixel of an image. The GLV pixels are arranged in a vertical line that can be 1,080 pixels long, for example. Light from three lasers, one red, one green and one blue, shines on the GLV and is rapidly scanned across the display screen at a number of frames per second to form the image.

One embodiment of the light projector is a 3D projector. In this embodiment, the projector 4 uses circular polarization—produced by a filter in front of the projector 4—to beam the film onto a screen (preferably silver screen). The filter converts linearly polarized light into circularly polarized light by slowing down one component of the electric field. When the vertical and horizontal parts of the picture are projected onto the silver screen, the filter slows down the vertical component. This effectively makes the light appear to rotate to create a 3D telepresence capability.

Another embodiment is a plurality of projectors 4 on the mobile device that forms a holographic projector. To create the hologram, cameras take color images at multiple angles and send them over the network. In one embodiment, images from the projectors 4 are projected onto a transparent plastic panel and refreshed every few seconds. In another embodiment, the phone is positioned flat on a table and the system creates an optical illusion that the image is floating above the screen. Preferably four to six projectors are used to form the holographic phone.

In one implementation, the light projector 4 and the camera 5 face opposite surfaces so that the camera 5 faces the user to capture user finger strokes during typing while the projector 4 projects a user interface responsive to the entry of data. In another implementation, the light projector 4 and the camera 5 on positioned on the same surface. In yet another implementation, the light projector 4 can provide light as a flash for the camera 5 in low light situations. The process projects a keyboard pattern onto a first surface using the light projector. The camera 5 is used to capture images of user's digits on the keyboard pattern as the user types and digital images of the typing is decoded by the processor 1 to determine the character being typed. The processor 1 then displays typed character on a second surface with the light projector. During operation, one head projects the user interface on a screen, while the other head displays a keyboard template onto a surface such as a table surface to provide the user with a virtual keyboard to “type” on. During operation, light from a light source internal to the phone 10 drives the heads. One head displays a screen for the user to view the output of processor 1, while the remaining head displays in an opposite direction the virtual keyboard using a predefined keyboard template. During operation, light from a light source internal to the phone drives the heads. The head displays a screen for the user to view the output of processor 1, while the second head displays in an opposite direction the virtual keyboard using a predefined keyboard template. The first head projects the user interface on a first surface such as a display screen surface, while the second head displays a keyboard template onto a different surface such as a table surface to provide the user with a virtual keyboard to “type” on.

The light-projector can also be used as a camera flash unit. In this capacity, the camera samples the room lighting condition. When it detects a low light condition, the processor determines the amount of flash light needed. When the camera actually takes the picture, the light projector beams the required flash light to better illuminate the room and the subject. In one embodiment, the head displays a screen display region in one part of the projected image and a keyboard region in another part of the projected image. In this embodiment, the screen and keyboard are displayed on the same surface. During operation, the head projects the user interface and the keyboard template onto the same surface such as a table surface to provide the user with a virtual keyboard to “type” on. Additionally, any part of the projected image can be “touch sensitive” in that when the user touches a particular area, the camera registers the touching and can respond to the selection as programmatically desired. This embodiment provides a virtual touch screen where the touch-sensitive panel has a plurality of unspecified key-input locations. When user wishes to input some data on the touch-sensitive virtual touch screen, the user determines a specific angle between the cell phone to allow the image projector to project a keyboard image onto a surface. The keyboard image projected on the surface includes an image of arrangement of the keypads for inputting numerals and symbols, images of pictures, letters and simple sentences in association with the keypads, including labels and/or specific functions of the keypads. The projected keyboard image is switched based on the mode of the input operation, such as a numeral, symbol or letter input mode. The user touches the location of a keypad in the projected image of the keyboard based on the label corresponding to a desired function. The surface of the touch-sensitive virtual touch screen for the projected image can have a color or surface treatment which allows the user to clearly observe the projected image. In an alternative, the touch-sensitive touch screen has a plurality of specified key-input locations such as obtained by printing the shapes of the keypads on the front surface. In this case, the keyboard image includes only a label projected on each specified location for indicating the function of each specified location.

In one embodiment, the wireless nodes convert freely available energy inherent in most operating environments into conditioned electrical power. Energy harvesting is defined as the conversion of ambient energy into usable electrical energy. When compared with the energy stored in common storage elements, like batteries and the like, the environment represents a relatively inexhaustible source of energy. Energy harvesters can be based on piezoelectric devices, solar cells or electromagnetic devices that convert mechanical vibrations.

Power generation with piezoelectrics can be done with body vibrations or by physical compression (impacting the material and using a rapid deceleration using foot action, for example). The vibration energy harvester consists of three main parts. A piezoelectric transducer (PZT) serves as the energy conversion device, a specialized power converter rectifies the resulting voltage, and a capacitor or battery stores the power. The PZT takes the form of an aluminum cantilever with a piezoelectric patch. The vibration-induced strain in the PZT produces an ac voltage. The system repeatedly charges a battery or capacitor, which then operates the EKG/EMG sensors or other sensors at a relatively low duty cycle. In one embodiment, a vest made of piezoelectric materials can be wrapped around a person's chest to generate power when strained through breathing as breathing increases the circumference of the chest for an average human by about 2.5 to 5 cm. Energy can be constantly harvested because breathing is a constant activity, even when a person is sedate. In another embodiment, piezoelectric materials are placed in between the sole and the insole; therefore as the shoe bends from walking, the materials bend along with it. When the stave is bent, the piezoelectric sheets on the outside surface are pulled into expansion, while those on the inside surface are pushed into contraction due to their differing radii of curvature, producing voltages across the electrodes. In another embodiment, PZT materials from Advanced Cerametrics, Inc., Lambertville, N.J. can be incorporated into flexible, motion sensitive (vibration, compression or flexure), active fiber composite shapes that can be placed in shoes, boots, and clothing or any location where there is a source of waste energy or mechanical force. These flexible composites generate power from the scavenged energy and harness it using microprocessor controls developed specifically for this purpose. Advanced Cerametric's viscose suspension spinning process (VSSP) can produce fibers ranging in diameter from 10 μm ( 1/50 of a human hair) to 250 μm and mechanical to electrical transduction efficiency can reach 70 percent compared with the 16-18 percent common to solar energy conversion. The composite fibers can be molded into user-defined shapes and is flexible and motion-sensitive. In one implementation, energy is harvested by the body motion such as the foot action or vibration of the PZT composites. The energy is converted and stored in a low-leakage charge circuit until a predetermined threshold voltage is reached. Once the threshold is reached, the regulated power is allowed to flow for a sufficient period to power the wireless node such as the Zigbee CPU/transceiver. The transmission is detected by nearby wireless nodes that are AC-powered and forwarded to the base station for signal processing. Power comes from the vibration of the system being monitored and the unit requires no maintenance, thus reducing life-cycle costs. In one embodiment, the housing of the unit can be PZT composite, thus reducing the weight.

In another embodiment, body energy generation systems include electro active polymers (EAPs) and dielectric elastomers. EAPs are a class of active materials that have a mechanical response to electrical stimulation and produce an electric potential in response to mechanical stimulation. EAPs are divided into two categories, electronic, driven by electric field, and ionic, driven by diffusion of ions. In one embodiment, ionic polymers are used as biological actuators that assist muscles for organs such as the heart and eyes. Since the ionic polymers require a solvent, the hydrated human body provides a natural environment. Polymers are actuated to contract, assisting the heart to pump, or correcting the shape of the eye to improve vision. Another use is as miniature surgical tools that can be inserted inside the body. EAPs can also be used as artificial smooth muscles, one of the original ideas for EAPs. These muscles could be placed in exoskeletal suits for soldiers or prosthetic devices for disabled persons. Along with the energy generation device, ionic polymers can be the energy storage vessel for harvesting energy. The capacitive characteristics of the EAP allow the polymers to be used in place of a standard capacitor bank. With EAP based jacket, when a person moves his/her arms, it will put the electro active material around the elbow in tension to generate power. Dielectric elastomers can support 50-100% area strain and generate power when compressed. Although the material could again be used in a bending arm type application, a shoe type electric generator can be deployed by placing the dielectric elastomers in the sole of a shoe. The constant compressive force provided by the feet while walking would ensure adequate power generation.

For wireless nodes that require more power, electromagnetics, including coils, magnets, and a resonant beam, and micro-generators can be used to produce electricity from readily available foot movement. Typically, a transmitter needs about 30 mW, but the device transmits for only tens of milliseconds, and a capacitor in the circuit can be charged using harvested energy and the capacitor energy drives the wireless transmission, which is the heaviest power requirement. Electromagnetic energy harvesting uses a magnetic field to convert mechanical energy to electrical. A coil attached to the oscillating mass traverses through a magnetic field that is established by a stationary magnet. The coil travels through a varying amount of magnetic flux, inducing a voltage according to Faraday's law. The induced voltage is inherently small and must therefore be increased to viably source energy. Methods to increase the induced voltage include using a transformer, increasing the number of turns of the coil, and/or increasing the permanent magnetic field. Electromagnetic devices use the motion of a magnet relative to a wire coil to generate an electric voltage. A permanent magnet is placed inside a wound coil. As the magnet is moved through the coil it causes a changing magnetic flux. This flux is responsible for generating the voltage which collects on the coil terminals. This voltage can then be supplied to an electrical load. Because an electromagnetic device needs a magnet to be sliding through the coil to produce voltage, energy harvesting through vibrations is an ideal application. In one embodiment, electromagnetic devices are placed inside the heel of a shoe. One implementation uses a sliding magnet-coil design, the other, opposing magnets with one fixed and one free to move inside the coil. If the length of the coil is increased, which increases the turns, the device is able to produce more power.

In an electrostatic (capacitive) embodiment, energy harvesting relies on the changing capacitance of vibration-dependant varactors. A varactor, or variable capacitor, is initially charged and, as its plates separate because of vibrations, mechanical energy is transformed into electrical energy. MEMS variable capacitors are fabricated through relatively mature silicon micro-machining techniques.

In another embodiment, the wireless node can be powered from thermal and/or kinetic energy. Temperature differentials between opposite segments of a conducting material result in heat flow and consequently charge flow, since mobile, high-energy carriers diffuse from high to low concentration regions. Thermopiles consisting of n- and p-type materials electrically joined at the high-temperature junction are therefore constructed, allowing heat flow to carry the dominant charge carriers of each material to the low temperature end, establishing in the process a voltage difference across the base electrodes. The generated voltage and power is proportional to the temperature differential and the Seebeck coefficient of the thermoelectric materials. Body heat from a user's wrist is captured by a thermoelectric element whose output is boosted and used to charge the a lithium ion rechargeable battery. The unit utilizes the Seeback Effect which describes the voltage created when a temperature difference exists across two different metals. The thermoelectric generator takes body heat and dissipates it to the ambient air, creating electricity in the process.

In another embodiment, the kinetic energy of a person's movement is converted into energy. As a person moves their weight, a small weight inside the wireless node moves like a pendulum and turns a magnet to produce electricity which can be stored in a super-capacitor or a rechargeable lithium battery. Similarly, in a vibration energy embodiment, energy extraction from vibrations is based on the movement of a “spring-mounted” mass relative to its support frame. Mechanical acceleration is produced by vibrations that in turn cause the mass component to move and oscillate (kinetic energy). This relative displacement causes opposing frictional and damping forces to be exerted against the mass, thereby reducing and eventually extinguishing the oscillations. The damping forces literally absorb the kinetic energy of the initial vibration. This energy can be converted into electrical energy via an electric field (electrostatic), magnetic field (electromagnetic), or strain on a piezoelectric material.

Another embodiment extracts energy from the surrounding environment using a small rectenna (microwave-power receivers or ultrasound power receivers) placed in patches or membranes on the skin or alternatively injected underneath the skin. The rectanna converts the received emitted power back to usable low frequency/dc power. A basic rectanna consists of an antenna, a low pass filter, an ac/dc converter and a dc bypass filter. The rectanna can capture renewable electromagnetic energy available in the radio frequency (RF) bands such as AM radio, FM radio, TV, very high frequency (VHF), ultra high frequency (UHF), global system for mobile communications (GSM), digital cellular systems (DCS) and especially the personal communication system (PCS) bands, and unlicensed ISM bands such as 2.4 GHz and 5.8 GHz bands, among others. The system captures the ubiquitous electromagnetic energy (ambient RF noise and signals) opportunistically present in the environment and transforming that energy into useful electrical power. The energy-harvesting antenna is preferably designed to be a wideband, omnidirectional antenna or antenna array that has maximum efficiency at selected bands of frequencies containing the highest energy levels. In a system with an array of antennas, each antenna in the array can be designed to have maximum efficiency at the same or different bands of frequency from one another. The collected RF energy is then converted into usable DC power using a diode-type or other suitable rectifier. This power may be used to drive, for example, an amplifier/filter module connected to a second antenna system that is optimized for a particular frequency and application. One antenna system can act as an energy harvester while the other antenna acts as a signal transmitter/receiver. The antenna circuit elements are formed using standard wafer manufacturing techniques. The antenna output is stepped up and rectified before presented to a trickle charger. The charger can recharge a complete battery by providing a larger potential difference between terminals and more power for charging during a period of time. If battery includes individual micro-battery cells, the trickle charger provides smaller amounts of power to each individual battery cell, with the charging proceeding on a cell by cell basis. Charging of the battery cells continues whenever ambient power is available. As the load depletes cells, depleted cells are switched out with charged cells. The rotation of depleted cells and charged cells continues as required. Energy is banked and managed on a micro-cell basis.

In a solar cell embodiment, photovoltaic cells convert incident light into electrical energy. Each cell consists of a reverse biased pn+ junction, where light interfaces with the heavily doped and narrow n+ region. Photons are absorbed within the depletion region, generating electron-hole pairs. The built-in electric field of the junction immediately separates each pair, accumulating electrons and holes in the n+ and p− regions, respectively, and establishing in the process an open circuit voltage. With a load connected, accumulated electrons travel through the load and recombine with holes at the p-side, generating a photocurrent that is directly proportional to light intensity and independent of cell voltage.

As the energy-harvesting sources supply energy in irregular, random “bursts,” an intermittent charger waits until sufficient energy is accumulated in a specially designed transitional storage such as a capacitor before attempting to transfer it to the storage device, lithium-ion battery, in this case. Moreover, the system must partition its functions into time slices (time-division multiplex), ensuring enough energy is harvested and stored in the battery before engaging in power-sensitive tasks. Energy can be stored using a secondary (rechargeable) battery and/or a supercapacitor. The different characteristics of batteries and supercapacitors make them suitable for different functions of energy storage. Supercapacitors provide the most volumetrically efficient approach to meeting high power pulsed loads. If the energy must be stored for a long time, and released slowly, for example as back up, a battery would be the preferred energy storage device. If the energy must be delivered quickly, as in a pulse for RF communications, but long term storage is not critical, a supercapacitor would be sufficient. The system can employ i) a battery (or several batteries), ii) a supercapacitor (or supercapacitors), or iii) a combination of batteries and supercapacitors appropriate for the application of interest. In one embodiment, a microbattery and a microsupercapacitor can be used to store energy. Like batteries, supercapacitors are electrochemical devices; however, rather than generating a voltage from a chemical reaction, supercapacitors store energy by separating charged species in an electrolyte. In one embodiment, a flexible, thin-film, rechargeable battery from Cymbet Corp. of Elk River, Minn. provides 3.6V and can be recharged by a reader. The battery cells can be from 5 to 25 microns thick. The batteries can be recharged with solar energy, or can be recharged by inductive coupling. The tag is put within range of a coil attached to an energy source. The coil “couples” with the antenna on the RFID tag, enabling the tag to draw energy from the magnetic field created by the two coils.

FIG. 5 shows an exemplary mesh network working with the wearable appliance of FIG. 6A. Data collected and communicated on the display 1382 of the watch as well as voice is transmitted to a base station 1390 for communicating over a network to an authorized party 1394. The watch and the base station is part of a mesh network that may communicate with a medicine cabinet to detect opening or to each medicine container 1391 to detect medication compliance. Other devices include mesh network thermometers, scales, or exercise devices. The mesh network also includes a plurality of home/room appliances 1392-1399. The ability to transmit voice is useful in the case the patient has fallen down and cannot walk to the base station 1390 to request help. Hence, in one embodiment, the watch captures voice from the user and transmits the voice over the Zigbee mesh network to the base station 1390. The base station 1390 in turn dials out to an authorized third party to allow voice communication and at the same time transmits the collected patient vital parameter data and identifying information so that help can be dispatched quickly, efficiently and error-free. In one embodiment, the base station 1390 is a POTS telephone base station connected to the wired phone network. In a second embodiment, the base station 1390 can be a cellular telephone connected to a cellular network for voice and data transmission. In a third embodiment, the base station 1390 can be a WiMAX or 802.16 standard base station that can communicate VOIP and data over a wide area network. I one implementation, Zigbee or 802.15 appliances communicate locally and then transmits to the wide area network (WAN) such as the Internet over WiFi or WiMAX. Alternatively, the base station can communicate with the WAN over POTS and a wireless network such as cellular or WiMAX or both.

The NFC 9 of FIG. 6B can serve the same function as the Zigbee to control home automation. The user can have flexible management of lighting, heating and cooling systems from anywhere in the home. The watch automates control of multiple home systems to improve conservation, convenience and safety. The mobile device can capture highly detailed electric, water and gas utility usage data and embed intelligence to optimize consumption of natural resources. The system is convenient in that it can be installed, upgraded and networked without wires. The patient can receive automatic notification upon detection of unusual events in his or her home. For example, if smoke or carbon monoxide detectors detect a problem, the wrist-watch can buzz or vibrate to alert the user and the central hub triggers selected lights to illuminate the safest exit route.

In another embodiment, the mobile device serves a key fob allowing the user to wirelessly unlock doors controlled by NFC or Zigbee wireless receiver. In this embodiment, when the user is within range, the door NFC transceiver receives a request to unlock the door, and the NFC transceiver on the door transmits an authentication request using suitable security mechanism. Upon entry, the NFC doorlock device sends access signals to the lighting, air-conditioning and entertainment systems, among others. The lights and temperature are automatically set to pre-programmed preferences when the user's presence is detected.

Although NFC and Zigbee is mentioned as exemplary protocols, other protocols such as UWB, Bluetooth, WiFi and WiMAX can be used as well.

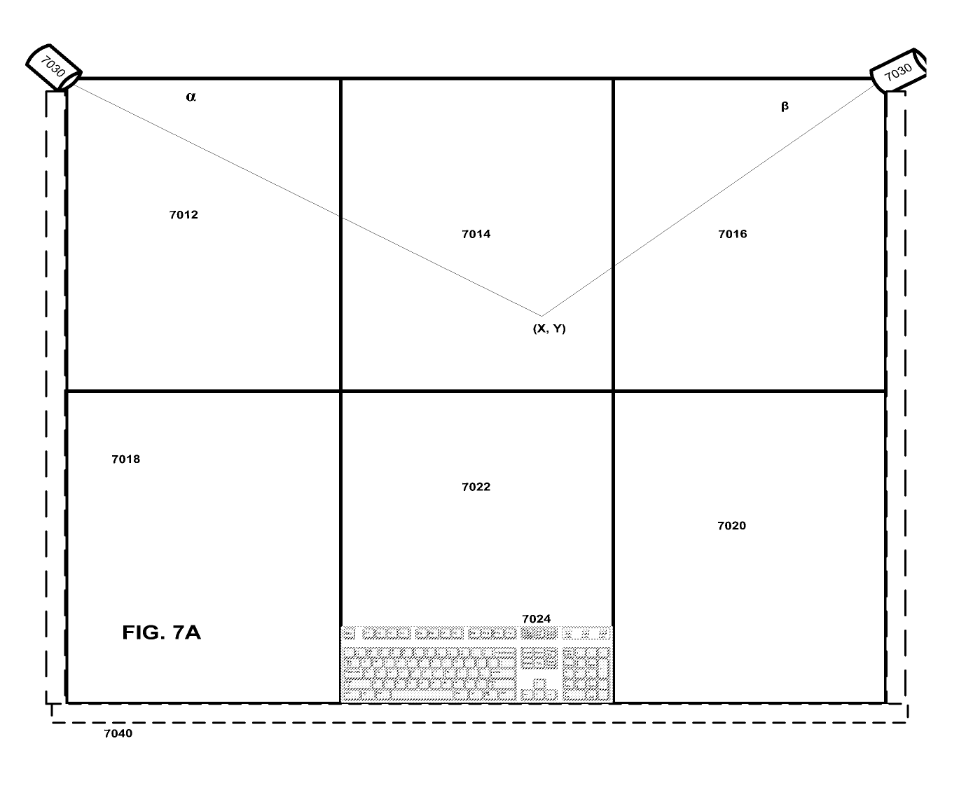

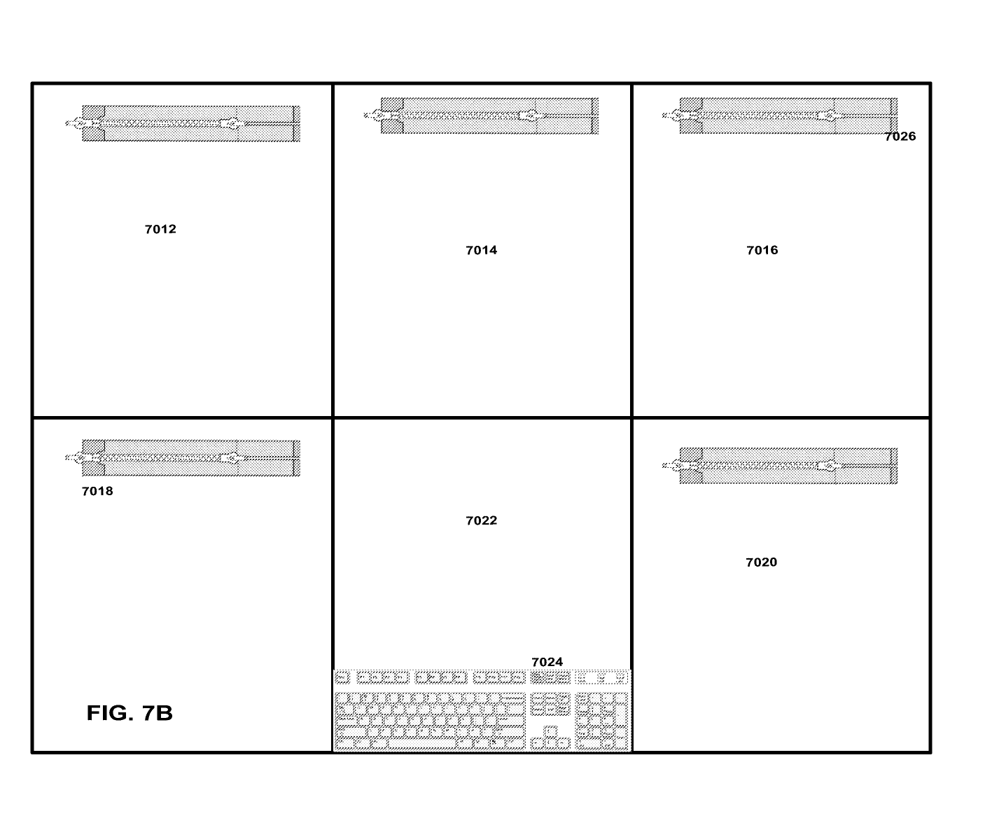

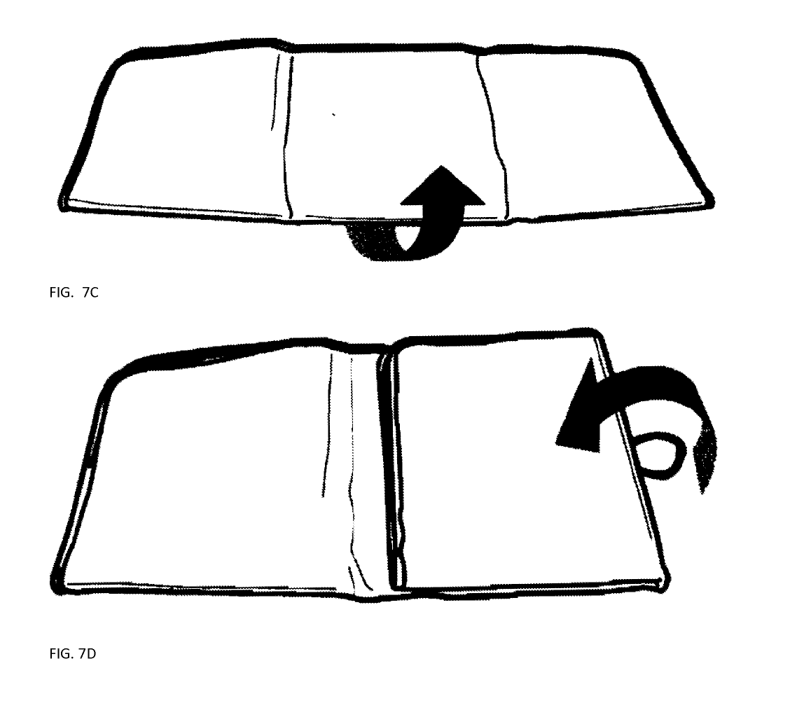

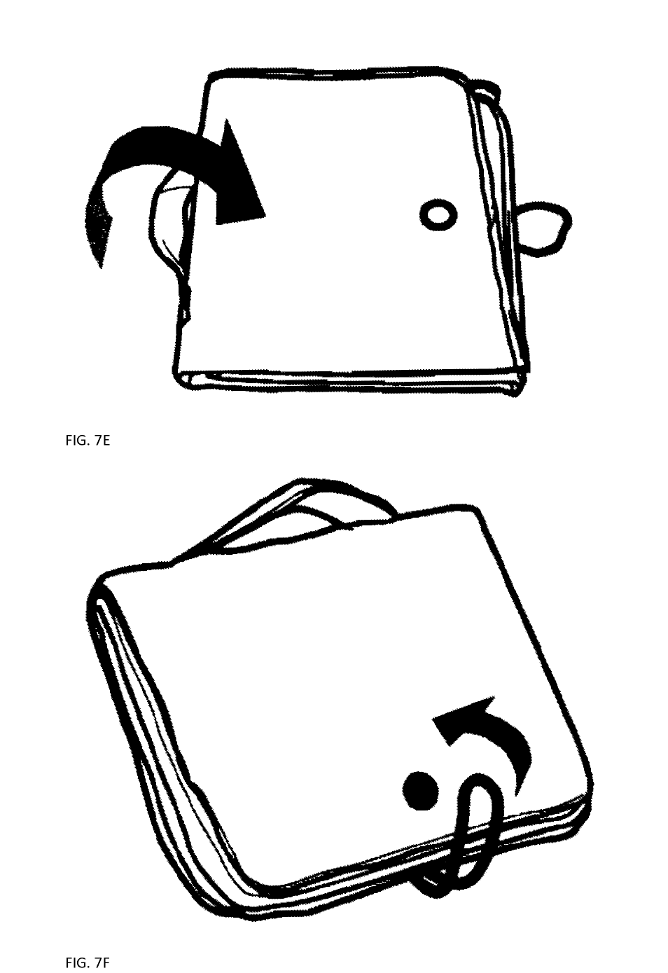

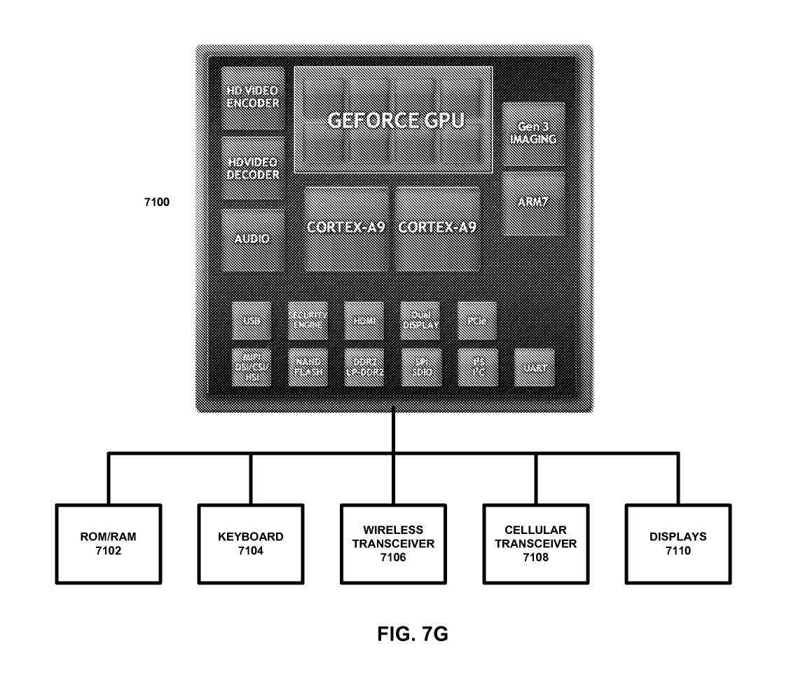

FIGS. 7A and 7B illustrate an exemplary flexible mobile computer with foldable display surfaces. Turning now to FIG. 7A, the flexbile computer includes a foldable flexible low power display with surfaces 7012-7020. The surfaces 7012-7020 can be folded like a newspaper during travel and unfolded to provide a large display surface for the user to work on. The flexible computer includes a keyboard 7024 that can be a physical keyboard or a virtual keyboard. For gesture recognition, cameras 7030 are positioned on opposite sides angles alpha and beta. The user can place his or her hand or finger to a position, and the camera can capture the finger position and allow gestures to be made in the air and recognized as discussed above. FIG. 7B is similar to FIG. 7A, but each of surfaces 7012-7020 can have a zipper 7026 that secures the contents in a pocket under the display surface. As shown in FIGS. 7C-7F, the surfaces can be folded up compactly as a digital portfolio carrier or a digital wallet. First, the user takes the bottom of the workstation and folds to the top of the workstation and the right flap is folded over to the middle region. Next, the user folds the left flap over to the middle region. To secure the portfolio, the user can attach a string to the outer button. Other alternative securing methods can be used, including a Velcro strap in place of the string, a lock, or a zipper around the flaps.

FIG. 7G shows an exemplary workstation hardware. In this system, a multi-core processor and graphic processing unit (GPU) device 7100 is used. The device 7100 is connected over a bus to memory 7102, keyboard 7104, wireless transceiver 7106, cellular transceiver 7108, and a plurality of display panels 7110. The memory 7102 can be flash memory that acts as a solid state disk drive for the workstation. In one embodiment, the keyboard 7104 is a physical keyboard (as opposed to a screen based keyboard) that provides tactile feedback to the user, the wireless transceiver 7106 is a WiFi or 802.XX type transceiver, the cellular transceiver 7108 is a 4G cellular modem, and the display panels 7110 are E-ink panels. Further, Near Field Communication (NFC) devices can be embedded into the digital wallet embodiment to support electronic commerce.

The device 7100 allows various processing tasks could be shared across the two cores. Due to task sharing, the cores don't need to run at full capacity and can be run at a lower frequency and voltage. Since the power consumption of semiconductor devices is proportional to the frequency and voltage-squared, even a small reduction in the operating frequency and voltage will result in significant reduction in power consumption. Therefore a mobile processor with a dual core CPU with SMP capabilities will often be more power efficient than a single core CPU based mobile processor. In one implementation, the device 7100 is a Tegra 2 from Nvidia with two processors, each a highly optimized version of the ARM® Cortex A9 MPcore™ architecture. However, additional cores such as quad-core and octa-core processors are contemplated.

The Symmetric Multiprocessing, out of order execution, and branch prediction features of the processor cores help deliver very fast Web page load times, snappy webpage rendering, and a smooth user interaction experience. The CPU cores are power managed through complex and highly intelligent Dynamic Voltage and Frequency Scaling algorithms. These algorithms are implemented at both the hardware and software level to ensure both cores are always operating at the optimal voltage and frequency levels to deliver the demanded performance, while consuming the lowest possible power. The multicore system is more power efficient and delivers higher performance per watt than competing solutions for the following reasons:

SMP technology can distribute and share task workloads across the two processing cores and thus each core is not fully loaded and does not have to run at peak capacity/speed. This enables the system level power management control logic to run the two cores at much lower operating frequency and voltage and thus achieve significant power savings for tasks that are highly parallel, device 100 is able to distribute the workload across the two CPU cores and complete the task much faster than a single core CPU solution.

Thus the dual core CPU would be able to complete a task quickly and enter into a low power state to conserve power, while a single core processor would have to be in an active high power state for longer periods of time to process the same task.

For low intensity workloads that only require the processing power of a single core, the other core can be turned off, reducing power consumption to almost the same level as that of a single core CPU. For example, if a Web page contains several scripts, streaming Flash video content, and script-based images, then in most cases, a single core CPU will be running at peak utilization, and to deliver peak performance, it will also be running at maximum operating voltage and frequency. For the same task running on a dual core CPU used in the SMP architecture, the Web browsing task is shared between the two processor cores. Therefore both cores need to run at only around 50% utilization to complete the task. Since the workload is shared, the cores can run at much lower voltage and frequency. Because each core processes only half the workload, each core can operate at almost half the frequency of the single core CPU, and therefore can run at a lower operating voltage. The device 100 is also optimized for playing Flash. Since Flash video playback and gaming involves graphics and pixel processing, the GPU core is better equipped to process these tasks efficiently and at high performance. In one embodiment, the OpenGL ES pipeline is fully leveraged to accelerate Flash-based graphics effect. A “style” describes how to render the inside of a Flash object on the screen. It could be a solid color, gradient fill, an image or video applied to the object, etc. The style also describes textures to apply, or which OpenGL ES vertex and pixel shaders to be used to achieve the desired rendering effect. Vertices are the basic building block of the 3D graphics pipeline, and are used to describe the outlines of the Flash objects. A variety of filter affects can be applied in a multi-pass process. Examples of filters include blurring an image, edge detection, applying highlights to an image, etc. Filter effects are implemented as fragment shaders, and also rendered with the GPU using OpenGL ES. Some complex scenes can be made up of more than 10 filter effects. The result of the rendering step is the final image, still stored in GPU memory. If capable, the browser can pull the image straight from GPU memory for further compositing into the web page. That compositing can also be done by the GPU, which will be an additional performance benefit.

In the video acceleration path in Flash, a video file first gets parsed and stored as a coded video stream inside a Flash player buffer. The coded video stream is then transferred to a hardware buffer where dedicated video hardware will process it, and produce a YUV image for each video frame. As the final rendering is always in RGB, the YUV image is converted to RGB color space by another hardware block. The resulting series of RGB images can simply be used as another rendering style, and rendered using OpenGL as textured quads.

Similar to Adobe Flash content processing, touch interactions trigger a significant amount of pixel processing, and most of the pixel processing for the user interface (UI) in current operating systems is performed by the CPU. Therefore to deliver fluid and snappy UI responsiveness even under heavy multi-tasking conditions, mobile processors must either have sufficient headroom in CPU processing power, or offload some of the UI-related pixel processing to a GPU core that is optimized to handle such tasks.

In one implementation, a method for increasing mobile processing power on a mobile device with a general purpose processor and one or more graphic processing units (GPUs) to accelerate graphic rendering on a screen includes separating general purpose software into parallelizable portions; running one or more parallelizable portions on one or more GPUs; and collecting GPU results.

The system can use GPUs for recognition of gestures in the air.

The system can use GPUs for eye tracking on the phone.

The system can use GPUs for electrocardiogram analysis on the phone.

The system can use GPUs for augmented reality on the phone.

The system can use GPUs for Doppler radar processing on the phone.

In one embodiment, the system can do on-the-fly augmented reality processing. For example, the system can auto translate signs from one language to another. First, the GPU identifies the letters on the sign. Next, it calculates their rotation and the perspective from which the viewer is seeing them. Then it tries to recognize each letter by consulting a library of reference font sets. A string of letters is generated, and a probabilistic word recognition is done. Upon recognizing the word, the system generates a synthetic version with the translation in the sign. The original language is erased and the existing orientation, foreground, and background color, which may be a gradient [rather than a constant color] are used to put new text on top.

In another embodiment, the computer (with or without the GPU) can work with eye gazing as a form of user input. In one embodiment, a method to provide user input to a mobile device having a camera therein to capture eye movements includes

tracking eye movement to detect a user request;

converting the user request into a requested user input; and

executing the requested user input and providing results to the user.

The system can determine user intent based on gaze tracking The system can detect eye movement to select a user interface item. The system can detect eye blink to select a user interface item. The system can detect eye movement and hand movement to perform a graphical user interface (GUI) control. The system can calibrate the camera by taking a picture of a left or right eye. The system includes calibrating the eye indoors and outdoors. The system can identify a person's eye at predetermined distances and under different lighting conditions during a learning phase. The system can track an eye position relative to a screen rather than where a person is looking The system can form a virtual box around an image of the eye, and recognize the eye inside the virtual box. The system can divide a camera image into a plurality of regions and locating the eye in one region. The system can authenticate the user with the eye movement. The system can detect eye movements following a moving icon around a screen. The system can detect one or more kinetic features unique to the user. During training, the system can move an icon across a screen to elicit distinct characteristics associated with the user. The icon can be moved rapidly to activate a predetermined sequence of eye movements; the icon can be moved smoothly or slowly to activate a second predetermined sequence of eye movements; and the eye movements are captured by the camera. The system can detect a four-finger swipe from side to side in order to switch and open apps, swiping up with four fingers to open an application switcher, or using a five-finger pinch to return to a home screen. The system can detect a gesture with two or more fingers simultaneously in the air. The method includes one of:

detecting pinching or stretching gestures in the air to control zooming;

waving a hand up or down in the air to scroll a display or moving a finger in the air to scroll a display;

tapping a finger in the air to click;

clicking or tapping with two fingers in the air to perform a secondary click;

performing a double tap in the air to look up information;

detecting gestures formed by one or more hands in the air to explain spatial ideas; tracing shapes with fingers in the air;

swiping with two or three fingers to move between pages of a document;

swiping with three or four fingers to move between full-screen applications;

displaying a launchpad by pinching in the air with thumb and three fingers; or

showing a desktop when a thumb and three fingers are spread in the air.

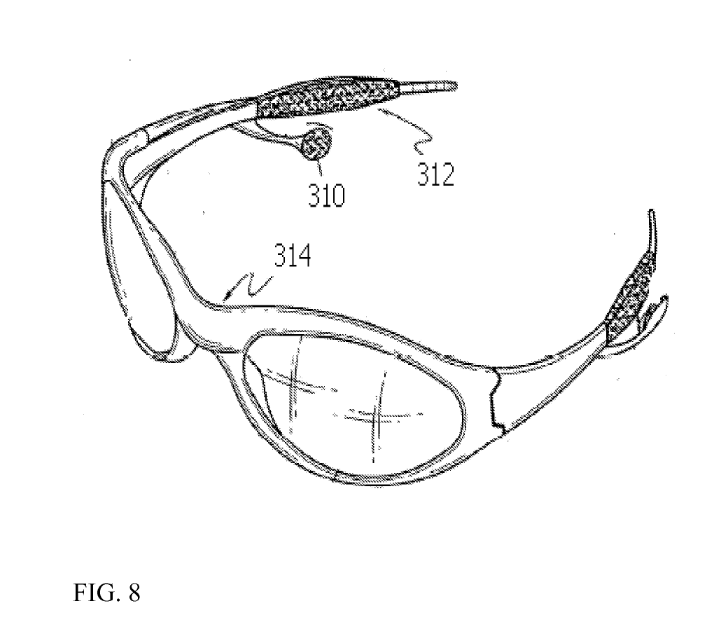

FIG. 8 shows a sunglass or eyeglass embodiment which contains electronics for communicating with the cellular and local wireless network. In this embodiment, a flexible LCD display is mounted above the eyeglass to superimpose data output from the processor and the cellular network connection. The superimposition of LCD display and viewing area is perfect for augmented reality applications. In this embodiment, a camera is positioned on the front of the eyeglass (between the two glasses) and the video feed is analyzed by processors in the eyeglass or processors located in the cloud server over the wireless network. The result of the analysis is sent back to the LCD display superimposed on the eyeglass. With augmented-reality displays, informative graphics will appear in the user's field of view, and audio will coincide with whatever the user sees. These enhancements will be refreshed continually to reflect the movements of the user's head. A projector can be mounted on the eyeglass to essentially turn any surface into an interactive screen. The device works by using the camera and mirror to examine the surrounding world, feeding that image to the phone (which processes the image, gathers GPS coordinates and pulls data from the Internet), and then projecting information from the projector onto the surface in front of the user, whether it's a wrist, a wall, or even a person. Because the user is wearing the camera on his eyeglass, the system can augment whatever he looks at; for example, if he picks up a can of soup in a grocery store, the system can find and project onto the soup information about its ingredients, price, nutritional value—even customer reviews.

With air gestures, a user can perform actions on the projected information, which are then picked up by the camera and processed by the phone. If he wants to know more about that can of soup than is projected on it, he can use his fingers to interact with the projected image and learn about, say, competing brands. The speaker can play digital audio file, which can be compressed according to a compression format. The compression format may be selected from the group consisting of: PCM, DPCM, ADPCM, AAC, RAW, DM, RIFF, WAV, BWF, AIFF, AU, SND, CDA, MPEG, MPEG-1, MPEG-2, MPEG-2.5, MPEG-4, MPEG-J, MPEG 2-ACC, MP3, MP3Pro, ACE, MACE, MACE-3, MACE-6, AC-3, ATRAC, ATRAC3, EPAC, Twin VQ, VQF, WMA, WMA with DRM, DTS, DVD Audio, SACD, TAC, SHN, OGG, Ogg Vorbis, Ogg Tarkin, Ogg Theora, ASF, LQT, QDMC, A2b, .ra, .rm, and Real Audio G2, RMX formats, Fairplay, Quicktime, SWF, and PCA, among others.

In one embodiment, the ear module 310 contains optical sensors to detect temperature, blood flow and blood oxygen level as well as a speaker to provide wireless communication or hearing aid. The blood flow or velocity information can be used to estimate blood pressure. The side module 312 can contain an array of bioimpedance sensors such as bipolar or tetrapolar bioimpedance probes to sense fluids in the brain. Additional bioimpedance electrodes can be positioned around the rim of the glasses as well as the glass handle or in any spots on the eyewear that contacts the user. The side module 312 or 314 can also contain one or more EKG electrodes to detect heart beat parameters and to detect heart problems. The side module 312 or 314 can also contain piezoelectric transducers or microphones to detect heart activities near the brain. The side module 312 or 314 can also contain ultrasound transmitter and receiver to create an ultrasound model of brain fluids. In one embodiment, an acoustic sensor (microphone or piezoelectric sensor) and an electrical sensor such as EKG sensor contact the patient with a conductive gel material. The conductive gel material provides transmission characteristics so as to provide an effective acoustic impedance match to the skin in addition to providing electrical conductivity for the electrical sensor. The acoustic transducer can be directed mounted on the conductive gel material substantially with or without an intermediate air buffer. In another embodiment, electronics components are distributed between first and second ear stems. In yet another embodiment, the method further comprises providing a nose bridge, wherein digital signals generated by the electronics circuit are transmitted across the nose bridge. The eyewear device may communicate wirelessly using the mesh network or alternatively they may communicate through a personal area network using the patient's body as a communication medium. Voice can be transmitted over the mesh wireless network.

In one embodiment, the eye wear device of FIG. 8 can provide a data port, wherein the data port is carried by the ear stem. The data port may be a mini-USB connector, a FIREWIRE connector, an IEEE 1394 cable connector, an RS232 connector, a JTAB connector, an antenna, a wireless receiver, a radio, an RF receiver, or a Bluetooth receiver. In another embodiment, the wearable device is removably connectable to a computing device. The wearable wireless audio device may be removably connectable to a computing device with a data port, wherein said data port is mounted to said wearable wireless audio device. In another embodiment, projectors can project images on the glasses to provide head-mounted display on the eye wear device. The processor can display fact, figure, to do list, and reminders need in front of the user's eyes.

In one embodiment, a method to provide user input to a mobile device having a camera therein, includes:

detecting a gesture formed by one or more body parts with the camera;

converting the detected gesture into a requested user input; and

executing the requested user input and providing results to the user.

The method includes detecting a four-finger swipe from side to side in order to switch and open apps, swiping up with four fingers to open an application switcher, or using a five-finger pinch to return to a home screen. The method includes detecting a gesture with two or more fingers simultaneously in the air. The method includes detecting pinching or stretching gestures in the air to control zooming. The method includes waving a hand up or down in the air to scroll a display. The method includes moving a finger in the air to scroll a display. The method includes tapping a finger in the air to click. The method includes clicking or tapping with two fingers in the air to perform a secondary click. The method includes performing a double tap in the air to look up information. The method includes detecting gestures formed by one or more hands in the air to explain spatial ideas. The method includes tracing shapes with fingers in the air. The method includes capturing a user's gesture in the air with the camera. The includes detecting swiping with two or three fingers to move between pages of a document. The method includes swiping with three or four fingers to move between full-screen applications. The method includes displaying a launchpad by pinching in the air with thumb and three fingers. The method includes showing a desktop when a thumb and three fingers are spread in the air. The method includes detecting user intent based on gaze tracking. The method includes detecting eye movement to select a user interface item. The method includes detecting eye blink to select a user interface item. The method includes detecting eye movement and hand movement to perform a graphical user interface (GUI) control.

In one embodiment, a method for transportation ticketing check-in includes prompting a traveler to place a handheld device within range of a near field communication (NFC) reader; retrieving ticketing and traveler identification information from the handheld device via the NFC reader; and verifying the traveler's identity using the retrieved traveler identification and historical geo-location of the traveler and the current position of the traveler. The method includes verifying the traveler's identity includes comparing a photograph retrieved from the handheld device to the traveler.

The method includes verifying the traveler's identity includes downloading a photograph of the traveler from a database using an identification code retrieved from the handheld device.

The method includes verifying the traveler's identity includes: downloading a fingerprint from a database using an identification code retrieved from the handheld device; and comparing the downloaded fingerprint to a scanned fingerprint provided by the traveler at check-in.

The method includes verifying the traveler's identity includes: downloading a first retinal scan from a database using an identification code retrieved from the handheld device; and comparing the downloaded first retinal scan to a second retinal scan provided by the traveler at check-in.

The method includes prompting the traveler to place the handheld device within range of the NFC reader again after successfully checking in; and updating the ticketing information on the handheld device to indicate that the traveler checked in successfully.

The method includes updating the ticketing information includes storing information about checked luggage on the handheld device.

The ticketing information includes a reservation for a flight, car rental, cruise, train, bus, or a combination thereof.

In one implementation, the method includes providing credit to a user for digital content in response to information from a tag associated with a product or service scanned by an electronic device, wherein the information includes an identification number associated with the product or service and wherein the credit may be exchanged for digital content from an online digital content service.

The tag includes a radio frequency identification tag and the credit is provided after the radio frequency identification tag is scanned by a near field communication interface of the electronic device, wherein the electronic device is a personal device belonging to the user.

The tag includes a radio frequency identification tag and the credit is provided after the radio frequency identification tag is scanned by a near field communication interface of the electronic device, wherein the electronic device is a kiosk.

Tag can be a matrix barcode and the credit is provided after the matrix barcode is scanned by a camera of the electronic device, wherein the electronic device is a personal device belonging to the user.

The tag includes a matrix barcode and the credit is provided after the matrix barcode is scanned by a matrix barcode scanner of the electronic device, wherein the electronic device is a kiosk.

A method includes providing a tag associated with a product or service, wherein the tag is configured to enable an electronic device to obtain information associated with at least one benefit related to the product or service, wherein the at least one benefit includes at least one digital content credit, wherein the at least one digital content credit is configured to be exchanged for digital content related to the at least one benefit from an online digital content service.

The product or service includes a product manual and wherein the at least one benefit related to the product or service includes troubleshooting assistance and the at least one digital content credit is configured to be applied to a download of instructional audio or video; wherein the at least one benefit related to the product or service includes an offer for another product or service and the at least one digital content credit is configured to be applied to a purchase of the other product or service; wherein the at least one benefit related to the product or service includes an offer for software and the at least one digital content credit is configured to be applied to a purchase of the software; wherein the at least one benefit related to the product or service includes an offer for a peripheral device and the at least one digital content credit is configured to be applied to a purchase of the peripheral device; wherein the at least one benefit related to the product or service includes offers for digital media downloads and the at least one digital content credit is configured to be applied to a purchase of the digital media downloads; or any combination thereof.

The product or service includes a magazine, magazine insert, or mailer, and wherein the at least one benefit related to the product or service includes a movie trailer and the at least one digital content credit is configured to be applied to a download of the movie trailer; wherein the at least one benefit related to the product or service includes an offer for a discounted product and the at least one digital content credit is configured to be applied to a purchase of the discounted product; wherein the at least one benefit related to the product or service includes a video advertisement and the at least one digital content credit is configured to be applied to a download of the video advertisement; wherein the at least one benefit related to the product or service includes a video game or software demonstration and the at least one digital content credit is configured to be applied to a download of the video game or software demonstration; wherein the at least one benefit related to the product or service includes free or discounted music or media and the at least one digital content credit is configured to be applied to a download of the free or discounted music or media; or any combination thereof.

The product or service includes a textbook and wherein the at least one benefit related to the product or service includes supplementary problems and the at least one digital content credit is configured to be applied to a download of the supplementary problems; wherein the at least one benefit related to the product or service includes answers to textbook problems and the at least one digital content credit is configured to be applied to a download of the answers to the textbook problems; wherein the at least one benefit related to the product or service includes instructional audio or video and the at least one digital content credit is configured to be applied to a download of the instructional audio or video; wherein the at least one benefit related to the product or service includes an offer for related study materials and the at least one digital content credit is configured to be applied to a purchase of the related study materials; wherein the at least one benefit related to the product or service includes further recommended reading and the at least one digital content credit is configured to be applied to a purchase of a related book or article; or any combination thereof.

The product or service includes a novel or non-fiction book and wherein the at least one benefit related to the product or service includes an author interview and the at least one digital content credit is configured to be applied to a download of the author interview; wherein the at least one benefit related to the product or service includes an offer for a related title and the at least one digital content credit is configured to be applied to a purchase of the related title; wherein the at least one benefit related to the product or service includes a movie trailer associated with the book and the at least one digital content credit is configured to be applied to a download of the movie trailer; wherein the at least one benefit related to the product or service includes press discussing the book and the at least one digital content credit is configured to be applied to a download of the press; or any combination thereof.

The product or service includes music or movie packaging and wherein the at least one benefit related to the product or service includes a movie trailer and the at least one digital content credit is configured to be applied to a download of the movie trailer; wherein the at least one benefit related to the product or service includes a review of the music or movie and the at least one digital content credit is configured to be applied to a download of the review; wherein the at least one benefit related to the product or service includes a free single and the at least one digital content credit is configured to be applied to a download of the free single; or any combination thereof.

The product or service includes software or video game packaging and wherein the at least one benefit related to the product or service includes a demonstration version of software sold in the software or video game packaging and the at least one digital content credit is configured to be applied to a download of the demonstration version of the software; wherein the at least one benefit related to the product or service includes a preview video of the software sold in the software or video game packaging and the at least one digital content credit is configured to be applied to a download of the preview video; wherein the at least one benefit related to the product or service includes a video describing how the software sold in the software or video game packaging was made and the at least one digital content credit is configured to be applied to a download of the video; wherein the at least one benefit related to the product or service includes hints or troubleshooting and the at least one digital content credit is configured to be applied to a download of troubleshooting audio or video; wherein the at least one benefit related to the product or service includes an instructional video and the at least one digital content credit is configured to be applied to a download of the instructional video; or any combination thereof.

The product or service includes grocery product packaging and wherein the at least one benefit related to the product or service includes related recipes and the at least one digital content credit is configured to be applied to a download of audio or video for the related recipes; wherein the at least one benefit related to the product or service includes an instructional video and the at least one digital content credit is configured to be applied to a download of the instructional video; or any combination thereof.

The product or service includes a restaurant menu or store exterior and wherein the at least one benefit related to the product or service includes advertising content and the at least one digital content credit is configured to be applied to a download of advertising audio or video; wherein the at least one benefit related to the product or service includes a dinner special and the at least one digital content credit is configured to be applied to a purchase of the dinner special; wherein the at least one benefit related to the product or service includes nutrition information and the at least one digital content credit is configured to be applied to a download of the nutrition information; wherein the at least one benefit related to the product or service includes an event calendar and the at least one digital content credit is configured to be applied to a download of the event calendar; wherein the at least one benefit related to the product or service includes discounted or prepaid food or merchandise and the at least one digital content credit is configured to be applied to a purchase of the discounted or prepaid food or merchandise; or any combination thereof.

The product or service includes food product packaging and wherein the at least one benefit related to the product or service includes free or discounted music and the at least one digital content credit is configured to be applied to a download of the free or discounted music; wherein the at least one benefit related to the product or service includes an option to buy a song currently playing in a restaurant pertaining to the food product packaging and the at least one digital content credit is configured to be applied to a purchase of the song currently playing in the restaurant; wherein the at least one benefit related to the product or service includes prepaid or discount food or drink and the at least one digital content credit is configured to be applied to a purchase of the prepaid food or drink; wherein the at least one benefit related to the product or service includes nutrition information and the at least one digital content credit is configured to be applied to a download of the nutrition information; wherein the at least one benefit related to the product or service includes a game piece or game software and the at least one digital content credit is configured to be applied to a download of the game piece or game software; wherein the at least one benefit related to the product or service includes advertisements for related food products and the at least one digital content credit is configured to be applied to a download of audio or video advertisements for the related food products; or any combination thereof.

The method includes marketing a benefit package comprising one or more benefits associated with a product or service to a manufacturer, supplier, distributor, or retailer of the product or service, wherein the one or more benefits associated with the product or service are configured to be accessible via an electronic device, wherein the electronic device is configured to provide a user of the electronic device with digital content related to the benefits associated with the product or service when a tag associated with the product or service is scanned by the electronic device, and wherein marketing the benefit package includes recommending the one or more benefits related to the product or service.

The marketing the benefit package can include recommending the one or more benefits related to the product or service based on the type of the product or service.

The product or service includes a product manual and the recommending the one or more benefits related to the product or service includes recommending a benefit of troubleshooting assistance; an instructional video; contact information of a provider of the product or service; offers for products; offers for software; offers for peripheral devices; offers for digital media downloads; or any combination thereof.

The product or service includes a magazine, magazine insert, or mailer, and the recommending the one or more benefits related to the product or service includes recommending a benefit of a movie trailer; offers for discounted products; video advertisements; video game or software demonstrations; free or discounted music or media; or any combination thereof.

The product or service includes a textbook and the recommending the one or more benefits related to the product or service includes recommending a benefit of supplementary problems; answers to textbook problems; instructional audio or video; a link to purchase related study materials; further recommended reading; or any combination thereof.

While this invention has been particularly shown and described with references to preferred embodiments thereof, it will be understood by those skilled in the art that various changes in form and details may be made therein without departing from the spirit and scope of the invention as defined by the appended claims.

What is claimed is:

1. An energy saving system, comprising:
a utility controller to transmit a signal for a demand response period or a peak energy price for a peak pricing period from a utility facility; and
a television display receiving the signal from the utility controller, the display having a first brightness mode operative during the demand response signal or the peak pricing period, and at least a second brightness mode for other period.

2. The system of claim 1, comprising a mobile device, wherein the display and an audio visual (AV) receiver are turned off during the demand response period or peak pricing period and AV output is rendered on the mobile device.

3. The system of claim 1, comprising a user override mode to ignore the utility demand response signal.

4. The system of claim 1, wherein the display and the AV amplifiers are disabled or turned off in response to the demand response signal.

5. The system of claim 1, comprising one or more AV appliances each having a power supply coupled to the utility controller, wherein the power supply of each AV appliance is disabled or turned off during the peak pricing period, wherein the AV appliance is selected from a group consisting of: a video player, a disc player, a DVD player, a Blu-ray player, a cable box, a digital satellite receiver, a set-top box, a videocassette recorder, and a streaming video device.

6. The system of claim 1, wherein the display comprises a first energy meter to determine energy consumption by the display and wherein the AV receiver comprises a second energy meter to determine energy consumption by the AV amplifier.

7. The system of claim 1, comprising a price display showing an energy cost of the entertainment system based on time of use (TOU) pricing.

8. The system of claim 1, comprising an incentive system communicating with the utility controller to motivate compliance with a demand response request from the utility facility.

9. The system of claim 1, comprising an audio video (AV) receiver coupled to the utility controller, the AV receiver including one or more audio amplifiers to drive external speakers, the audio amplifiers being disabled or turned off during the demand response signal or peak pricing period.

10. The system of claim 1, wherein the AV receiver provides power to one or more audio appliances, wherein the AV appliance comprises a video player, a disc player, a DVD player, a Blu-ray player, a cable box, a digital satellite receiver, a set-top box, a videocassette recorder, a streaming video device.

11. The system of claim 1, comprising a heater receiving the signal from the utility controller, the heater having a first temperature mode operative during the demand response signal or the peak pricing period, and at least a second temperature mode for other period.

12. The system of claim 1, comprising an air conditioner receiving the signal from the utility controller, the air conditioner having a first temperature mode operative during the demand response signal or the peak pricing period, and at least a second temperature mode for other period.

13. The system of claim 1, comprising a water heater receiving the signal from the utility controller, the water heater having a first temperature mode operative during the demand response signal or the peak pricing period, and at least a second temperature mode for other period.

14. The system of claim 1, comprising a refrigerator receiving the signal from the utility controller, the refrigerator having a first temperature mode operative during the demand response signal or the peak pricing period, and at least a second temperature mode for other period.

15. The system of claim 1, comprising a light controller receiving the signal from the utility controller, the light controller having a dim light mode operative during the demand response signal or the peak pricing period, and at least a full light mode for other period.

16. The system of claim 1, comprising a washer receiving the signal from the utility controller, the washer being disabled during the demand response signal or the peak pricing period, and enabled for other period.

17. The system of claim 1, comprising a dryer receiving the signal from the utility controller, the dryer being disabled during the demand response signal or the peak pricing period, and enabled for other period.

18. The system of claim 1, comprising a battery charger receiving the signal from the utility controller, the battery charger reversing operation to put power into an electrical grid during the demand response signal or the peak pricing period, and charging a battery during the other period.

19. The system of claim 1, wherein the signal is transmitted over the power line or a wireless link.

20. The system of claim 1, comprising a normative messaging system coupled to the utility controller to provide specific suggestions to a customer to save energy by replacing an appliance or reducing room temperature or display brightness.
